(19) United States
(12) Patent Application Publication
(10) Pub. No.: US 2011/0258003 A1
(43) Pub. Date: Oct. 20, 2011

(54) Advanced Messaging System and Method

(76) Inventor: Nicholas Anthony Lindsay Brown, (US)

(21) Appl. No.: 13/171,545

(22) Filed: Jun. 29, 2011

Related U.S. Application Data
(63) Continuation of application No. 12/173,770, filed on Jul. 15, 2008.
Application No. 12/173,770 is a continuation of application No. 10/700,720, filed on Nov. 3, 2003, now abandoned.
Application No. 10/700,720 is a continuation-in-part of application No. 10/273,961, filed on Oct. 16, 2002, now abandoned.
Application No. 10/700,720 is a continuation-in-part of application No. 09/894,644, filed on Jun. 27, 2001, now abandoned.
Application No. 09/894,644 is a continuation-in-part of application No. PCT/US02/33584, filed on Oct. 16, 2002.
(60) Provisional application No. 60/456,138, filed on Mar. 19, 2003.
(60) Provisional application No. 60/329,773, filed on Oct. 16, 2001.
(60) Provisional application No. 60/338,770, filed on Dec. 5, 2001.
(60) Provisional application No. 60/342,607, filed on Dec. 21, 2001.
(60) Provisional application No. 60/214,088, filed on Jun. 27, 2000.

(51) Int. Cl. G06Q 50/00; G06Q 20/00; G06Q 40/00

(52) U.S. Cl. 705/3; 705/39

(57) ABSTRACT

Using an advanced messaging system, customers can purchase goods or services from a vendor without either the vendor or the advanced messaging system itself having access to sensitive financial information of the customer. At the advanced messaging system, the customer connects an identifier of their account at the financial institution with an order identifier from the vendor, allowing a transfer of funds to take place between the customer and the vendor associated with an order. An alternative use of an advanced messaging system is for the transfer of funds between accounts. Another alternative use of an advanced messaging system is the secure management and transfer of customer medical information between multiple systems under the control of the customer. Another alternative use of an advanced messaging system is the secure management and transfer of customer information between multiple systems under the control of the customer.

The present application is a continuation of U.S. patent application Ser. No. 12/173,770, filed Jul. 15, 2008, which is a continuation application claiming the benefit under 35 USC Section 120 of U.S. patent application Ser. No. 10/700,720, filed Nov. 3, 2003 which is a nonprovisional of U.S. Provisional Patent Application Ser. No. 60/456,138, filed Mar. 19, 2003, and is a continuation-in-part of U.S. patent application Ser. No. 10/273,961, filed Oct. 16, 2002 which is a nonprovisional of U.S. Provisional Patent Application Ser. No. 60/329,773, filed Oct. 16, 2001, a nonprovisional of U.S. Provisional Patent Application Ser. No. 60/338,770, filed Dec. 5, 2001, and a nonprovisional of U.S. Provisional Patent Application Ser. No. 60/342,607, filed Dec. 21, 2001, and is a continuation-in-part of U.S. patent application Ser. No. 09/894,644, filed Jun. 27, 2001 which is a nonprovisional of U.S. Provisional Patent Application Ser. No. 60/214,088, filed Jun. 27, 2000. The present application is a continuation-in-part of PCT Patent Application Serial Number PCT/US02/33584 filed Oct. 16, 2002. The present application is based on and claims priority from these applications, the disclosures of which are hereby expressly incorporated herein by reference.

### BACKGROUND OF INVENTION

The present invention is directed to a single source money management system.

### Money & Credit

The history of purchasing finances begins with simple barter in which parties exchange resources, goods, or services for mutual advantage. “Money” developed from shells in 1200 BC, to the first metal coins in 1000 BC, to leather money in 118 BC, to paper money in 906 AD. The history of credit began in Assyria, Babylon, and Egypt approximately 3000 years ago and developed to bills of exchange in the 1300's. It was not until the 1700's that a true innovator placed the first advertisement for credit by offering furniture that could be paid off weekly. In the 1920s, a shopper's plate (a “buy now, pay later” system) was introduced in the United States. In 1950, Diners Club and American Express launched their charge cards in the United States, the first “plastic money.” These original charge cards were accepted in only a few establishments. The establishment of standards for the magnetic strip in 1970 revolutionized credit cards and brought them into the information age.

Credit cards are a successful means for conducting financial transactions because they are almost globally accepted. Customers (e.g. buyers of goods or services) like credit cards because they give them additional buying power (they can make purchases and pay them off monthly), are convenient to use, lightweight to carry (as opposed to cash and checks), and provide a convenient means to keep track of expenditures (statements). Vendors like credit cards because customers are more likely to make purchases, especially expensive purchases, using a credit card than with cash because the customer has the opportunity to pay off the purchase over time. Credit card issuers make a profit by charging sellers fees.

Another form of credit is a traditional loan (e.g. home loans, equity loans). Obtaining a loan is generally a complicated, time consuming, process requiring lots of paperwork. Loans are generally only given to people who have established credit histories or significant collateral. Because of the problems associated with obtaining a traditional loan, they are generally only obtained for large purchases such as cars and homes. Profits for lenders are made by charging fees (e.g. junk fees) as well as a percentage based on the length and amount of the loan (e.g. interest). Smaller term loans for purchases of two thousand to five thousand dollars are not economically feasible for most lenders or borrowers due to the cost of the loan application and credit processing.

Some employers will allow employees to have a cash advance on future paychecks by following a generally humiliating process of asking the boss or human resource department for a loan based on an “emergency” or “exigent circumstances,” and the often time consuming and/or difficult process of filling out forms or other paperwork. This “perk” is really just allowing the employee access to his money.

Some employers have begun to recognize that automatic payroll deductions can be used to allow an employee to pay for computers and some finance companies have started to offer programs by which employers can offer their employees credit card-like products that are paid using payroll deductions. These programs, however, are complicated (e.g. they require the employer to develop specific policies and procedures) and risky to the employer (e.g. if the employee quits, dies, is fired, or otherwise leaves the employer's company, the employer runs a high risk of never being paid back). The problems are enough to prevent most employers from implementing such programs.

The credit card-like products that have been introduced in the last few years are generally administered by third parties and can be offered by employers as a benefit to their employees. The card in these credit card-like products may be used in a manner similar to a credit card for purchases, but payments are deducted from the employee's paycheck using automatic payroll deduction. These credit card-like products are extremely limited in scope and have strict limitations such as who can participate (e.g. age requirements), minimum salary requirements, the percentages of the paycheck that may be spent, and the products that can be purchased.

### Paychecks

Barter was sufficient for simple exchanges of services in which one neighbor would assist another neighbor hunt, gather, or build. The use of money to pay for services occurred naturally as money developed. Until recently, employees were paid with a paycheck at predetermined periods. In the last ten years, however, automatic payroll deposit became popular. One advantage of automatic payroll deposit is that it relieved the employee from the burden of having to deposit their checks. This was especially convenient if the employee was not available on payday due to illness, traveling, or vacation. Employers no longer had to print checks and deliver the paycheck to the employees. Employees and employers both liked the convenience of automatic payroll deposit. Financial institutions (e.g. banks and credit unions) liked automatic payroll deposit because it was less labor intensive because it reduced the number of tellers and processing personnel necessary to process payroll checks.

Automatic payroll deductions (APDs) have become a universal means for withholding taxes and a widely used means for paying a myriad of periodic fees such as taxes, social security, insurance, union dues, charitable contributions, retirement savings (401(k)), and other savings/investment plans. To use automatic payroll deductions, the employee, through the employer, sets up certain deductions that are to be periodically deducted from his paycheck. Automatic payroll deduction, however, requires the employee to set up payments through the employer. This is work intensive for the employer who must set up the automatic payroll deductions. It also means that the employee must relinquish a certain amount of privacy to the employer. What is left is the employee's net pay.

As mentioned above, some employers will allow employees to have a cash advance on future paychecks. To avoid the humiliating process of begging for their own money, some employees have turned to third parties to get cash advances. Although traditional “brick and mortar” establishments have traditionally accomplished this, the service is now being offered online by at web sites such as www.mycashnow.com and www.cashadvancenow.com. These online services provide short-term cash advances that are electronically deposited into the individual's checking account. Of course, this requires an individual to provide sensitive banking information (e.g. a bank statement) and access to his accounts to a sometimes unknown third party for the deposit of funds and/or the withdrawal of funds. The third parties also charge relatively large fees for their services.

### Paying Bills

Today, an individual must pay a multiplicity of payees. The monthly process of bill payment can take hours, as the individual must locate all the bills that need to be paid, write the checks, balance the accounts, find envelopes (and write the address thereon if they have not been pre-addressed) and stamps (at an additional cost), and verify that the previous month's payments have been received by the respective payees. A missing bill or a lost payment can result in the addition of hours of extra work and probable surcharges to this cumbersome and risky bill payment process.

With the advent of the internet, people wanted to make payments online. Mailing traditional payment or transferring funds proved cumbersome. The use of credit cards online is fraught with security risks. New financial models began to be developed. Some financial institutions began to offer electronic bill pay services in which the financial institutions pay clients' bills using electronic fund transfers. Third party bill pay services (e.g. CheckFree) also began to offer programs, for a fee, in which payments were authorized online. Some of the authorized payments were paid through electronic fund transfers by the bill pay services. For payees that were not set up to receive payments electronically, the bill pay service would write a check and mail it through the postal service. Legitimate bill pay services offer payment guarantees that provide extra security.

U.S. Pat. No. 6,347,305 to Watkins is directed to a method for selecting and processing payroll deduction as a payment option for articles purchased during electronic commerce. An employer authorizes selected vendors involved in electronic commerce to accept payroll deduction as a payment option for the employer's employees. The employer and vendor establish guidelines for utilizing the payroll deduction option during electronic commerce and the vendor stores the guidelines and identifying information for the employer and corresponding employees in a database in the vendor's computer. Thereafter, when an employee selects articles from the vendor's web site, the employee may select payroll deduction as the payment option. The vendor places the employee's selections and payment option in a file and forwards them to the employer. The employer may approve or reject the employee's selection and the vendor processes the order according to the employer's instructions. Then the vendor informs the employee about the status of the order. This method is fraught with problems. First, it is only available for electronic commerce. Second, this method requires extensive set-up, intervention, interaction, and other involvement by both the employer and the vendor. Both employers and vendors would be resistant to implementing any program that required such extensive involvement. Third, because the employer is being asked to review the employee's selection, the employee is subject to both a loss of privacy and the virtual version of the humiliation of asking for access to his own pay.

### Online Payments

As mentioned above, with the advent of the internet, customers want to make payments online and are leery of the use of credit cards online because of known security risks. Some financial institutions offer electronic bill pay services in which the financial institutions pay clients' bills using electronic fund transfers. Third party bill pay services (e.g. CheckFree) offer programs, for a fee, in which payments were authorized online.

One service that offers a means for online payment is PAYPAL®. PAYPAL® allows users to send money for such purposes as paying for an auction item, paying for an online purchase, or paying bills online. In fact, PAYPAL® allows a user to send money to anyone with an email address by entering the recipient's email address and the amount of the desired payment. The recipient gets an email informing them that payment has been sent and instructions on how to collect by visiting PAYPAL®'s web site. PAYPAL® receives its payment by credit card or checking account.

A digital wallet is a software component that allows a user to make an electronic payment with a financial instrument (such as a credit card or a digital coin) during electronic commerce transactions, and hides the low-level details of executing the payment protocol that is used to make the payment. In its ideal form, a digital wallet should be able to accommodate all of the user's different payment instruments (e.g. a user's credit cards and digital coins, and other financial instruments yet to be developed) and inter-operate with multiple payment protocols. A digital wallet can hold a user's payment information, a digital certificate to identify the user, and shipping information to speed transactions. The consumer benefits because his information is encrypted against piracy and because some wallets will automatically input shipping information at the merchant's site and will give the consumer the option of paying by digital cash or check. Merchants benefit by receiving protection against fraud. Most digital wallets reside on the user's PC, but recent versions, called “thin” wallets, are placed on the credit card issuer's server.

### Money Management

Keeping track of money has become an almost impossible task. Although payroll can now be automatically deposited, there is a myriad of deductions (e.g. taxes, 401k) that are taken out of the payroll before it is deposited. In existing money management systems, each individual has a monthly responsibility and commitment to micromanage his own money. Every period, after receiving his net pay, the individual must pay a multiplicity of payees. Some of the payments require the writing and mailing of a traditional check. Some of the payments are grouped together and paid together by paying a credit card bill. Some of the payments are automatically deducted from the individual's checking account. Some of the payments must be authorized online.

For large payments, such as rent, an individual who receives multiple paychecks in a month may have to combine multiple paychecks to cover the large expense. For example, if an individual who receives $1000 net pay on a weekly basis may have a $2000 monthly rent payment. The individual could allot the first two paychecks of a month to paying the rent. This would leave him cash poor in the first two weeks of a month. A better approach for the individual would be to save $500 for rent each week, leaving $500 for other expenses. This approach, however, requires discipline.

Savings present another struggle in basic money management. Ideally, in addition to paying monthly bills, individuals would put aside money for retirement or other savings. Some accomplish this using automatic payroll deduction. Others, not wanting to risk employer mismanagement or wanting to protect their privacy, try to do it themselves. Too often, this results in little or no savings.

The present invention is directed to features that may be used in conjunction with the inventions disclosed in into U.S. patent application Ser. No. 09/894,644 to Saylors and entitled “Web Dependent Consumer Financing and Virtual Reselling Method” and U.S. patent application Ser. No. 10/273,961 to Saylors et al. and entitled “Web Dependent Self-Administered Automatic Payroll Deduction” (the “Saylors references”). The disclosures of the Saylors references are hereby incorporated herein by reference.

### BRIEF SUMMARY OF THE INVENTION

The present invention is directed to a single source money management system through which customers may automate their committed spending. A money management account and a discretionary fund account are established, preferably at a financial institution, in response to a customer's request to participate in the system. The financial institution receives money on a periodic basis from a customer's predictable payment system having automatic payment capabilities. The money is then deposited/transferred to the money management account, retained in the money management account as required for bill payment, and/or deposited/transferred into the discretionary fund account if it is “excess.” Bills are paid on a customer determined schedule directly from the money management account using the money retained in the money management account.

In one preferred embodiment of the present invention, a loan account may be established in response to a customer's application for a loan account. A financial institution grants a loan for a loan purchase in response to a customer's application for a loan purchase. The system and/or the financial institution handles payment for the loan purchase and repayment of the loan from the loan account from the money management account.

In one preferred embodiment of the present invention, the single source money management system includes a secure internet shopping system that includes a vendor web system and a financial institution web system. Each vendor offers goods and/or services. The financial institution web system permits customer authorization of payment to a selected vendor.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a schematic diagram of a prior art traditional money management system.

FIG. 2 is a schematic diagram of an exemplary embodiment of a single source money management system of the present invention that includes a money management account.

FIG. 3 is an exemplary screen image of a screen that a customer might use to schedule payments using the money management account.

FIG. 4 is a schematic diagram of an exemplary embodiment of the components of the single source money management system and particularly the automated flow of funds managed by the financial institution.

FIG. 5 is a schematic diagram of an exemplary embodiment of the advanced messaging system of the present invention and exemplary paths therebetween.

FIG. 6 is a schematic diagram of exemplary system elements of an exemplary advanced messaging system of the present invention and its relationship with other system elements.

FIG. 7 is a schematic diagram of an exemplary embodiment of a single source money management system of the present invention including a loan account.

FIG. 8 is a simplified flowchart of exemplary steps of the method for using a loan account.

FIG. 9 is a schematic diagram of exemplary embodiments of the advanced messaging system and other system components used to implement the loan account of the present invention.

FIG. 10 is an exemplary screen image of a payment method page from which the customer may select payment options including a loan from a loan account.

FIG. 11 is an exemplary screen image of a loan insurance page from which the customer may select insurance options on a loan from a loan account.

FIG. 12 is an exemplary screen image of a loan summary page.

FIG. 13 is an exemplary screen image of a loan final approval page.

FIGS. 14 and 15 are flow charts of an exemplary embodiment of variable bill processing implemented using the single source money management system of the present invention.

FIG. 16 is an exemplary screen image of an authorization email for variable bill processing.

FIG. 17 is an exemplary screen image of an authorization page for variable bill processing.

FIG. 18 is a schematic diagram of exemplary system elements of the present invention used to implement a variable bill processing system.

FIGS. 19 and 20 are schematic diagrams of exemplary system elements of the present invention used to implement first and second parts of a customer's purchase of goods using an exemplary secure internet shopping system of the present invention.

FIG. 21 is an exemplary screen image of a secure internet shopping hub web site.

FIG. 22 is an exemplary screen image of an exemplary vendor's web site.

FIG. 23 is a schematic diagram of exemplary system elements of the present invention used to implement a return of goods using an exemplary secure internet shopping system of the present invention.

FIG. 24 is a schematic diagram of exemplary system elements of the present invention used to implement a customer's purchase of services using an exemplary secure internet shopping system of the present invention.

FIG. 25 is an exemplary screen image of an account summary.

FIG. 26 is a simplified flowchart of an exemplary embodiment of the process for linking of sources of information used in the present invention.

FIG. 27 is a schematic diagram of exemplary system elements of the present invention used to implement the displaying of linked information.

FIG. 28 is a schematic diagram of exemplary system elements of the present invention used to implement payee self-registration.

FIG. 29 is a schematic diagram of exemplary system elements of the present invention used to permeate customer profile updates throughout the network.

FIG. 30 is a schematic diagram of an exemplary customer accessible system that could be used to access the single source money management system of the present invention through a financial institution.

### DETAILED DESCRIPTION OF THE INVENTION

The present invention builds on and improves on the inventions disclosed in U.S. patent application Ser. No. 09/894,644 and U.S. patent application Ser. No. 10/273,961, both of which are owned by the assignee of the present invention and which are hereby incorporated herein by reference.

U.S. patent application Ser. No. 09/894,644 is directed to a web dependent consumer financing and virtual reselling method that includes a virtual reseller credit program. The virtual reseller credit program is preferably implemented, at least in part, over an electronic communication media (referred to throughout this specification as the internet or the web) that includes an employed customer seeking to finance the purchase of a product, an employer, a lender (which may be the financial institution), and a credit-risk reducer (referred to throughout this specification as insurance and/or deposit protection devices) that may be credit insurance or a recourse reserve fund. The lender's decision to fund the employed customer may be based, at least in part, on the employed customer's employment (and the employer's agreement to use automatic payroll deductions) and/or the presence of the credit-risk reducer. In one preferred embodiment of the invention, a virtual reseller is used to order and deliver, sometimes using third parties, the product on behalf of the employed customer. The virtual reseller may also monitor repayment of the credit and automatically detect late payments.

U.S. patent application Ser. No. 10/273,961 is directed to a self-administered automatic payroll deduction that preferably includes a method for allowing an employed customer to self-administer automatic payroll deductions from his gross pay through a money management system. Preferably, the employed customer self-registers in the money management system via the web or other electronic communication media. Then the employed customer may submit at least one transaction request to facilitate a financial obligation to at least one vendor. The system then arranges for payment of the financial obligation and directs the payroll system to withdraw funds from the employed customer's gross pay (using at least one automatic payroll deduction) and to transfer the withdrawn funds to the at least one vendor. In one preferred embodiment, the system provides access to a lender-vendor to arrange financing for the financial obligation and to a credit-risk reducing feature such as insurance.

The present invention is directed to a single source money management system. The heart of the invention is the use of a money management account 110 (that also can be referred to as a payment or bill pay account) into which money may be deposited directly from payroll using automatic deposit. Recurring bills may be paid on a user-determined schedule directly from the money management account 110. The remaining excess funds may then be automatically transferred from the money management account 110 into a discretionary fund account 112 (e.g. a checking account). In other words, the money management account 110 allows the average consumer to segregate committed spending from discretionary spending held in the discretionary fund account 112. The present invention allows individuals to have a sense of control, comfort, and peace of mind by allowing them to master their money by using powerful tools to harness and leverage their cash flow.

Another crucial element of the present invention is an advanced messaging system 124 (which may also be referred to as a “network” or “networking system”) designed to securely transmit information and facilitate a wide variety of online services (e.g. direct deposit, shopping, messaging, and account aggregation). The advanced messaging system 124 is unique because digital information from different sources is independently authorized to be linked together by the user and yet is simultaneously under the control of the user. In addition, sensitive information is maintained by the originator of the sensitive information. Instead, one time unique transaction codes are recognized by the different components of the single source money management system to facilitate transmissions and transfers.

Additional subsystems that may be incorporated in the single source money management system include, but are not limited to, a loan account, a payroll advance account, variable bill processing, secure internet shopping, secure online collection of sensitive information, internet ATM/POS transaction processing, payee registration throughout the network, customer updates permeating through the network, and payee self-registration for automatic payment. These subsystems may be unique in and of themselves and may function as stand-alone systems.

The system of the present invention will have advantages for all parties involved as well as for society as a whole. Customers are able to automate their committed spending which, at the very least, frees up time for more important activities. Customers also may use the system to improve their credit, save, and otherwise control their finances. Vendors will appreciate a systemic improvement in consumer credit quality which will result in more secure financial transactions. Financial institutions will benefit from increased customer loyalty and reduced transaction costs. Charities may receive donations they otherwise might not have received. Even the government will benefit because funds can be transferred electronically which would reduce the demand for coins and currency.

### Money Management Account

As mentioned, the single source money management system of the present invention includes the direct deposit of an employee's (customer's) paycheck into a money management account 110 (or other predictable payment system). The money management account 110 is linked to a bill pay system such that funds retained in this money management account 110 are used to pay bills (as determined by the bill pay system 118). The remaining funds are automatically deposited in or transferred to a discretionary fund account 112. This is a natural but unique extension of the direct deposit process as it “idealizes” the intent of the wage earner by automatically segregating committed spending from discretionary spending. Because the system is automated, the customer is able to automate their committed spending.

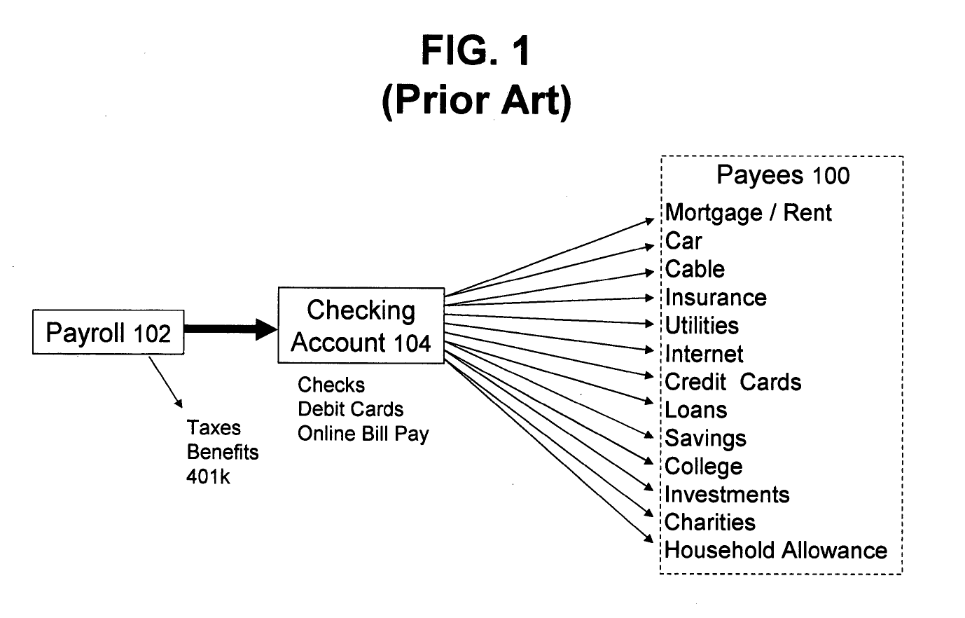

FIG. 1 shows a traditional money management system in which an individual must pay a multiplicity of payees 100. In this system, a paycheck from payroll 102 is deposited directly into a checking account 104. The multiplicity of payees 100 are then paid using traditional methods such as checks, debit cards, and online bill pay. If the individual wants to keep track of how much money remains from his paycheck after all the bills are paid, he must do so manually (or with the use of specialty software). If the individual wants to keep track of how much money remains in his checking account 104 after all the bills are paid, he must do so manually (or with the use of specialty software) because the financial institution can only keep track of funds that have gone through the system and been actually paid.

As an extremely simplistic example of the system shown in FIG. 1, an individual receives $1000 net pay (paycheck from payroll 102) 102 on a weekly basis that is deposited directly to his checking account 104. He must pay $2000 on the last day of the month for rent. He also has a $300 car payment due on the 15^{th} of each month. His other expenses include utilities and cable for a total of $500 that are due throughout the month. He has no plans for investments or charities. When he receives his first paycheck, he might pay some of the utilities (using checking or an online bill pay service). Although he knows he should save some of the remainder of his money for rent, this requires discipline. His second check may be used for paying the car payment. Again, he should save some of the remainder of his money for rent. The remaining two paychecks must be completely allocated for rent.

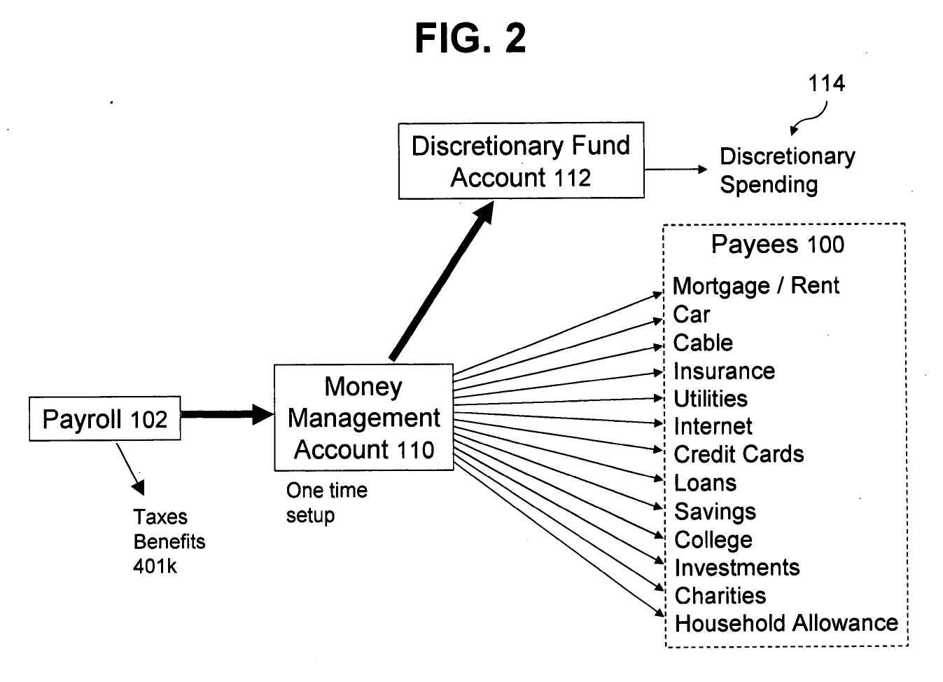

FIG. 2 shows an exemplary embodiment of a single source money management system of the present invention in which an individual must pay a multiplicity of payees 100. In this system, a paycheck from payroll 102 is deposited directly into a money management account 110. In one preferred system, the money management account 110 may be set up at the individual's own financial institution so that security is not a risk factor for the individual. In such a situation, the single source money management system is an add-on to the financial institution's electronic bill pay services. The appropriate funds are calculated and held in the money management account 110 and remaining funds are automatically deposited in or transferred to a discretionary fund account 112 (which may be a traditional checking account). The multiplicity of payees 100 are paid automatically and preferably paid electronically using, in one preferred embodiment, a standard financial institution bill pay system 118.

Using the single source money management system shown in FIG. 2, the individual always knows how much of his money from each paycheck is available for discretionary spending because the information is available as the deposit/transfer into the discretionary fund account 112 which the individual may then use for discretionary spending 114. It should be noted that the balance of the discretionary fund account 112 might not reflect withdrawals from or checks written on the discretionary fund account 112 as they might not have cleared the system. Still, the balance of the discretionary fund account 112 should reflect an amount close to the true balance available for discretionary spending. One preferred embodiment of the present invention includes a check register subsystem that allows the individual to monitor withdrawals and deposits to the discretionary fund account 112 by recording withdrawals in the check register subsystem. In alternate preferred embodiments of the present invention, a check register subsystem that allows the individual to monitor withdrawals and deposits to the discretionary fund account 112 may be a stand-alone system (e.g. specialty software) or may be incorporated into currently available money management software such as QUICKEN®, QUICK BOOKS®, TURBOTAX®, or MICROSOFT MONEY®.

Using the figures from the simplistic example above as applied to the system shown in FIG. 2, an individual receives $1000 net pay (paycheck from payroll) 102 on a weekly basis that is deposited directly to his money management account 110. As in the simplistic example above, his monthly expenses include $2000 for rent, $300 for a car payment, and $500 for utilities and cable. In this example, however, the individual additionally invests $100 and donates $100 to charity. Unlike the previous example, the individual does not have to monitor when payments are due as they are handled automatically. Every week the individual has transferred $250 from the money management account 110 to the discretionary fund account 112. The system would handle all the details. If a ledger were kept, however, it might look like Table 1.

TABLE 1

| Day of Month | Deposit | Withdrawal | Balance | Comment |
|---|---|---|---|---|
| 1 | | | $0 | |
| 7 | $1,000 | | $1,000 | Paycheck |
| 7 | | $250 | $750 | Transfer to |
| | | | | discretionary fund |
| 10 | | $100 | $650 | Investment |
| 11 | | $100 | $550 | Charity |
| 11 | | $200 | $350 | Utility #1 |
| 14 | $1,000 | | $1,350 | Paycheck |
| 14 | | $250 | $1,100 | Transfer to |
| | | | | discretionary fund |
| 15 | | $300 | $800 | Car payment |
| 18 | | $100 | $700 | Cable |
| 20 | | $200 | $500 | Utility #2 |
| 21 | $1,000 | | $1,500 | Paycheck |
| 21 | | $250 | $1,250 | Transfer to |
| | | | | discretionary fund |
| 28 | $1,000 | | $2,250 | Paycheck |
| 28 | | $250 | $2,000 | Transfer to |
| | | | | discretionary fund |
| 30 | | $2,000 | $0 | Rent |

The individual receives weekly transfers to his discretionary fund account 112 of $250, he is freed from the task of constantly managing his money, and he has allocated regular funds for investment and charity. As will be explained below, the individual is in complete control of scheduling his payments.

It should be noted that in this preferred embodiment of the invention it is the customer's responsibility to schedule the first bill payments at a time when there will be sufficient funds in the money management account 110. The present invention may include an alarm or notice feature to alert the customer 120 if the initial scheduling is problematic. The customer 120 may be advised that a first way to correct an initial scheduling problem is to provide initial funds into the money management account 110 to cover bills scheduled to be paid before sufficient funds become available. The customer 120 may be advised that a second way to correct the problem is to contact the goods or service provider to reschedule the due date. The customer 120 may also be advised that a third way to correct the problem is to obtain a loan account or payroll advance account that can be used to make current any past due bills. A fourth way to correct the problem is to have an overflow account (which may be any sufficiently funded account belonging to the customer 120) from which funds are collected/used. Assuming that sufficient funds are available from the customer 120 to cover anticipated bills, future monthly payment processes would be automated for as long as he is employed.

It should be noted that after the initial setup period, it becomes the system's responsibility to schedule bill payment at times when there will be sufficient funds in the money management account 110. Should the system detect that sufficient funds will not be available to cover anticipated expenses (e.g. a change in salary or payment on commission where the funds vary), the present invention may include an alarm or notice feature to alert the customer 120. The customer 120 may be advised to correct insufficient funds problems using the methods discussed to correct initial scheduling problems. The customer 120 may have the option to pre-select a back-up plan to cover such an insufficient fund situation. For example, the customer 120 may indicate during setup (or at any other time) that if there should be insufficient funds in his money management account 110, funds may be transferred first from his discretionary fund account 112 if there are funds available and second from a regular savings account. It should be noted that the customer 120 may indicate during setup (or at any other time) that if there should be insufficient funds from his payroll for a desired deduction, whether a partial payment or no payment should be made toward that deduction. Preferably the customer 120 is allowed to decide the priority of his deductions, but in a preferred embodiment, certain payments may be designated as priority payments (e.g. repayments of a loan account 140). It should be noted that the present invention may take into consideration any payroll processors rules, state laws, and/or federal laws that dictate which (if any) options may be available to the customer 120.

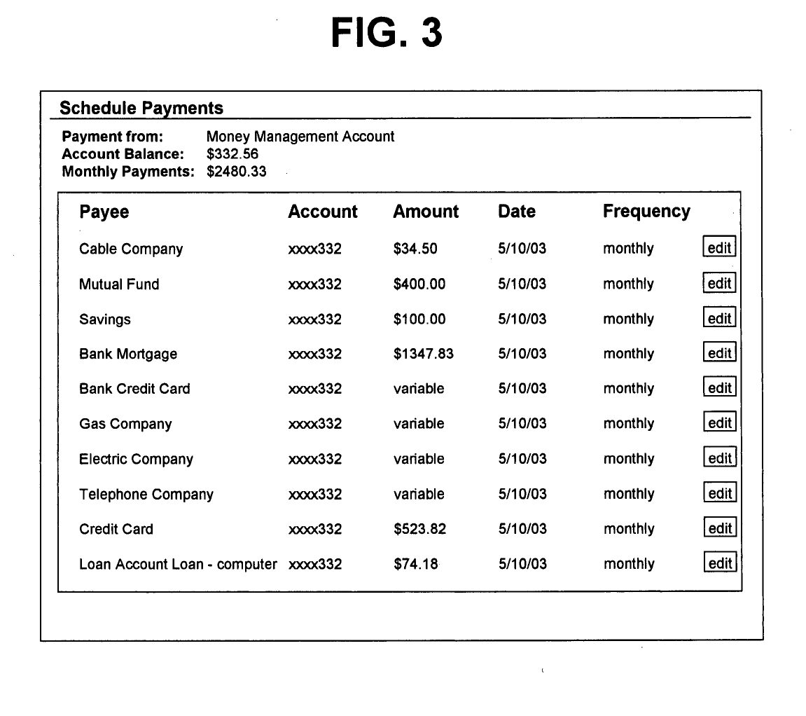

FIG. 3 shows an exemplary screen image of a screen that a customer 120 might use to schedule payments using the money management account 110. The customer 120 is given options and flexibility to add, remove, and update payees 100. Each payee has an associated payee account number. If the payee is a periodic payee (as opposed to a variable payee which will be discussed below), the payee also has a periodic amount, a send date, and a frequency. As mentioned above, in this preferred embodiment of the invention it is the customer's responsibility to schedule the first bill payments at a time (send date) when there will be sufficient funds in the money management account 110. After that, however, the bill pay system 118 would forward/increase the send date by the appropriate frequency (e.g. monthly or annually). A screen image such as that shown in FIG. 3 would also provide a customer 120 information on the total periodic (shown as monthly) payments scheduled. In one preferred embodiment, the user might be prompted with a pop-up window should the system detect that sufficient funds will not be available to cover anticipated expenses.

The single source money management system integrates many features of known systems to obtain a completely unique system that has never been implemented before. For example, automatic payroll deposit, electronic bill pay services, and money management software all exist, but have never been combined. By integrating these three features into a single source money management system, the individual user is able to completely monitor and control their funds without the burden of micromanagement. Further, using a money management account 110 in conjunction with these features allows an individual's funds to accumulate and be allocated automatically without the problem of the individual removing funds allocated for bill pay. The discretionary fund account 112 allows the individual to have access to all funds not previously allocated.

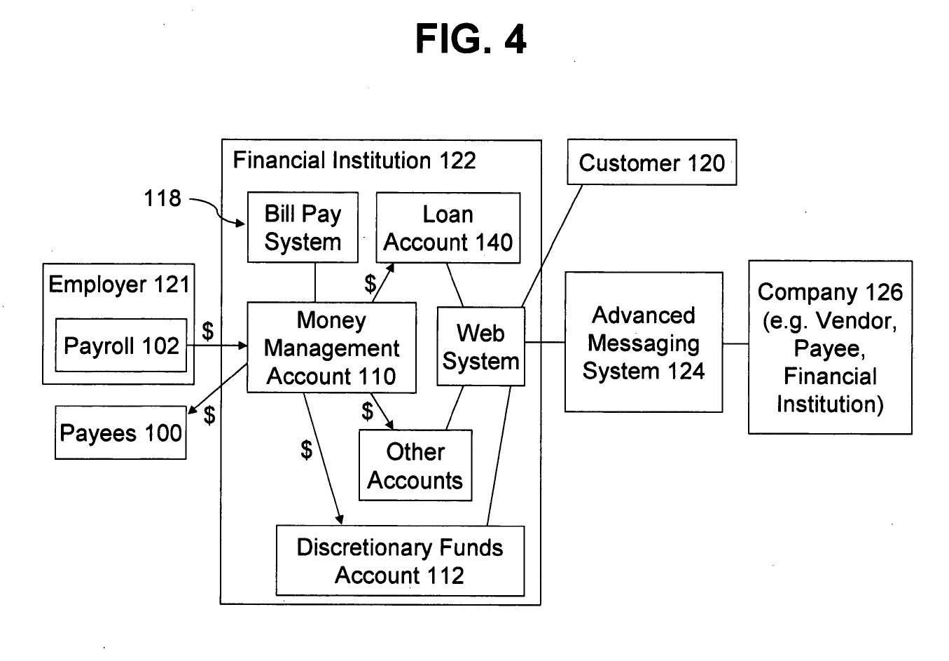

FIG. 4 shows an exemplary embodiment of the components of the single source money management system of the present invention and exemplary paths therebetween. Specifically, FIG. 4 shows the automated flow of funds managed by the financial institution 122 designated by an arrow and a $ sign. The financial institution 122 manages the funds based on instructions provided by the customer 120. In this exemplary embodiment, payroll 102 is deposited directly into the money management account 110. Un-retained funds are transferred to the discretionary funds account 112. It should be noted that one alternative embodiment could have payroll being deposited directly into the discretionary funds account 112 and funds required to be retained are then transferred to the money management account 110. It should be noted that another alternative embodiment could have payroll divided so that appropriate portions are being deposited directly into the money management account 110 and the discretionary funds account 112. A bill pay system 118 then distributes funds to payees 100, and possibly also to other accounts within the financial institution, including possibly a loan account 140 as described below. This process is all automated. This figure also shows the interconnection between these components of the single source money management system and other components of the single source money management system. The customer 120 has access through the financial institution's web system to all of his accounts, and through an advanced messaging system 124 (as described below) to other companies 126 (e.g. vendors 128, insurers 130, payees 100), that are also part of the single source money management system. Functions available to the customer 120 through the single source money management system are extensive, some of which are detailed below.

It should be noted that the single source money management system is a compilation of one or more entities selected from the group consisting of predictable payment sources (e.g. employers 121), financial institutions 122, advanced messaging system(s) 124, insurers 130, vendors 128, payees 100, other businesses/institutions, and customers 120. These entities may also include associated software and/or web sites associated with each specific entity. The software and/or web sites of the various entities are preferably networked together for appropriate flow of information to implement the invention. Depending on the implementation, the single source money management system may be accessed using the software and/or web site associated with any of these entities. For example, employers 121 may provide access to the single source money management system to their employees, financial institutions 122 may include a link to the system, and vendors 128 may provide a link offering payment for goods using the single source money management system. The “single source money management system web site,” for the purpose of this invention, therefore, may be thought of as the site of access to the system.

It should be noted that although this invention has been discussed in terms of the source of funds being directly deposited being an employee/customer's paycheck, alternate embodiments are also contemplated within the scope of the invention. For example, the source of funds for the money management account 110 may include, for example, interest payments, dividends, collected rents, member draws, automatic bill payments (e.g. from this invention), insurance payments, welfare checks, social security payments, other government payments, manual payments or deposits (e.g. a check written by the customer 120), regularly scheduled automatic transfers of funds from an alternative account, and most other sources of funds. This could also include revenue sources or royalties for individuals or businesses.

### Advanced Messaging System

The advanced messaging system 124 of the present invention is a unique networking system in which different information sources are independently authorized to be linked together by the user such that transfers of digital information remain under the control of the user. This feature of the present invention responds to the increasing need for an improvement in security of sensitive information. Because the advanced messaging system 124 is able to identify the user and, thereby know the user's preferences, the system 124 is able to securely identify, create, and/or maintain the appropriate links. For example, a customer 120 may log on and connect to the network through his financial institution's web site. The customer 120 may then log on to any company 126 that is connected to the network (e.g. AMAZON.COM®, AMERICAN EXPRESS®, AMERICAN AIRLINES®), and request a link to the network. Information from linked company 126 (e.g. account information) may be displayed on the financial institution's web site at the user's request. The advanced messaging system 124 of the present invention will identify, create, and/or maintain this link. Another example is that the same customer 120 may order some goods at a vendor's web site, select to purchase the goods through the network (thus linking the order to the network), and authorize the payment at his financial institution's web site (e.g. in one preferred embodiment the customer 120 is allowed to select a payment source from a list of linked accounts) which is already linked to the advanced messaging system 124. Again, the advanced messaging system 124 of the present invention will identify, create, and/or maintain a link between the customer's financial account and the order. Depending on the customer's preferences, the advanced messaging system 124 may complete the financing of the purchase between the vendor 128 and the financial institution 122 on behalf of the customer 120. Preferably, details of the financial account are not required by or provided to the vendor 128 and details of the order are not required by or provided to the financial institution 122 to facilitate the purchase. One unique feature of the present invention, therefore, is that in a preferred embodiment, the advanced messaging system 124 facilitates a financial institution's web system on which a customer 120 may directly authorize the purchase of goods/services from an account held by that financial institution 122.

Once information sources are securely linked and under control of the customer 120 through an advanced messaging system 124, the possibility opens for numerous uses for both the information and the network. Some of the numerous uses are detailed below (e.g. secure internet shopping, account aggregation, variable bill presentment/payment, and payee registration throughout network). Not only do the numerous uses benefit the customer 120, but they also benefits every entity connected to the network. The numerous uses of the advanced messaging system 124 satisfy the increasing need of all businesses/organizations and the individual to share a wide range of digital information, yet still allow the individual control over who has access to it.

It is not necessary for each entity connecting to an advanced messaging system 124 to know the full details of other entities connecting to the advanced messaging system 124 that are involved in a specific transaction, provided the advanced messaging system 124 itself has enough information to complete required functions. In order to increase security within the advanced messaging system 124, it is preferable that a minimum amount of information regarding each entity connecting to the advanced messaging system 124 be transmitted to other entities connecting to the advanced messaging system 124 in any transaction sequence using the advanced messaging system 124.

A first preferred embodiment of the advanced messaging system 124 retains transaction specific information necessary for the routing and completion of a specific transaction sequence in a database maintained by the advanced messaging system 124, to be accessed and used by the advanced messaging system 124 during a later step in the transaction sequence. For example, a financial institution's customer wishing to purchase a product from a vendor 128 begins by the customer 120 being transferred to the advanced messaging system 124. The advanced messaging system 124 may store the customer's financial information (e.g. the financial institution identifier and the financial institution's customer identifier) in a database, and pass the customer 120 to the vendor 128 without the customer's financial information, but with a unique transaction code created by and used within the advanced messaging system 124. The vendor 128 has no need to know the customer's financial information. Once the customer 120 has selected goods and wishes to purchase them, the customer 120 is returned to the advanced messaging system 124. The advanced messaging system 124 retrieves the customer's financial information from the database, and stores details regarding the purchase (order information) that the financial institution 122 does not need to know, like the identification of the vendor 128 and the specifics of what was purchased. The customer 120 is now passed back to the appropriate financial institution 122 with the financial institution's customer identifier, the price of goods to be purchased, and a unique transaction code created by and used within the advanced messaging system 124. The transaction will continue in this manner until the transaction is complete, with the financial institution 122 knowing minimal details pertaining to the vendor 128 or the goods purchased, and the vendor 128 knowing minimal details pertaining to the financial institution 122 from which the customer 120 is paying for those goods.

A second preferred embodiment of the advanced messaging system 124 provides the same level of information security as the first preferred embodiment but instead of retaining and retrieving information (e.g. the customer's financial information and the order information) from a database within the advanced messaging system 124, this second preferred embodiment passes this information along with the transaction itself in a secure manner, for example by encrypting it. In the first preferred embodiment of the advanced messaging system 124, when the customer 120 is sent to the vendor 128, the customer's financial information could be encrypted and sent with the customer 120 to the vendor 128. This encrypted information, when returned from the vendor 128, would be decrypted to identify the customer's financial information. The vendor 128 and order information could also be encrypted and sent along to the financial institution 122 with the customer 120. The encryption and decryption preferably occurs only on the advanced messaging system 124, and thus would be extremely secure against unauthorized decryption. In other words, no other companies or individuals would know the required keys to break the encryption. In addition, it is possible to make the second preferred embodiment even more secure by adding to the information being encrypted a continually varying variable (e.g. a timestamp) resulting in a different encryption result every time the same information is encrypted. This adds even more security to the entire process, as it is now possible to decrypt information and tell whether it was originally encrypted on the advanced messaging system 124 (i.e. does it make sense once the information has been decrypted), or whether it was an attempt by a third party to imitate a transaction.

A third preferred embodiment of the advanced messaging system 124 could include an easy method for “defining a use” of the advanced messaging system 124 (e.g. secure internet shopping). In this embodiment the advanced messaging system 124 can be used to accomplish almost any messaging use, but the use must be defined. A programmer would define the specific uses and the rules for each use. For example, a programmer could define the use of the advanced messaging system 124 to be secure internet shopping. A completely different type of use could be defined to facilitate student, parent, teacher, and administrator communications within a school or school district. Yet another completely different type of use could be defined to facilitate transactions associated with health care including but not limited to patient appointments (e.g. scheduling and reminders), insurance verification and payment, secure transmission of prescriptions, and communications between medical personnel (e.g. obtaining opinions or information from specialists for the same patient, interoffice communications between doctors and nurses, and transferring patient files to a new primary care physician). Yet another example could be the transfer of relevant information between appropriate parties involved in the purchase of a house and applying for the mortgage for the purchase. A single advanced messaging system 124 could facilitate multiple uses if a programmer defined multiple uses for the system. Multiple advanced messaging systems 124 may be able to concurrently perform the same use by using the same set of rules, thus allowing load balancing across multiple physical systems. Definitions of a use of an advanced messaging system 124 could be in the form of a table that includes instructions defining each possible situation that may occur in the completion of this use, and the actions to be taken in each situation. An example of this could be for an advanced messaging system 124 providing secure internet shopping. One of the situations defined could be receiving a customer 120 from a vendor 128 with an order, where the instructions could include storing the order in a database, decrypting financial institution information included in the message, identifying the required financial institution 122, identifying insurance options, and sending the customer 120 to a financial institution 122. There are multiple advantages of this third preferred embodiment. A change in the rules of a use of the system can be accomplished by reloading the advanced messaging system 124 with a new table containing the new rules.

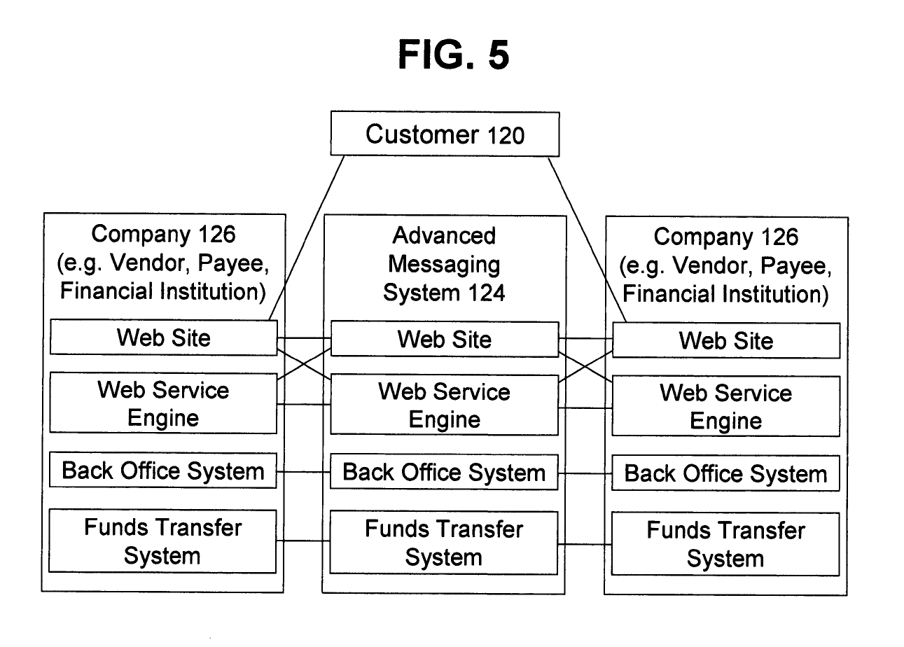

FIG. 5 shows an exemplary embodiment of different components of the advanced messaging system 124 of the present invention and exemplary paths therebetween. Specifically, FIG. 5 is a high level depiction of how different companies 126 within the advanced messaging system 124 can connect to the advanced messaging system 124. Customers 120 can connect to any company 126 (e.g. financial institution 122, payee 100, vendor 128, or any other entity associated with the single source money management system of the present invention) through the company's web site. Passing of information and/or the customer 120 between companies 126 and the advanced messaging system 124 can be done multiple ways including but not limited to web sites, web service engines, back office systems, or funds transfer systems.

Network security and availability will be one of the most critical aspects of one preferred embodiment of the advanced messaging system 124 of the present invention. The advanced messaging system 124 of the present invention necessitates a constantly available network, web presence and internet connectivity. For this reason, the entire production web application environment is to be constructed in a “no single point of failure” model. The “no single point of failure” model will keep critical applications constantly available, allow rapid connectivity, and allow maintenance to occur without effecting end user connectivity. Another preferred security feature of the advanced messaging system 124 of the present invention is that every aspect and function is redundant and configured for active/active failover. For example, the firewalls are preferably session aware, and sandwiched between Firewall Load Balancers (FWLB). The firewalls preferably have a heartbeat connection between them, as will the FWLB's. Preferably, the FWLB's will constantly (4 times per second) perform “route out” health checks, and adjust traffic according to network health.

Another critical portion of the networking system's preferred embodiment of the production environment is the web, web application, communications, and database computers, which actually house the application and supporting architecture. The web content may reside on multiple identical web servers, serviced by redundant server load balancers (SLB). Identical clustered web servers will ensure that in the event of hardware or software failure, the system's web site remains available to end users and everyone else connected to the system. The SLB group is preferably interconnected and individual session aware; meaning that if any web server, switch, or SLB in the group fails, the user session will automatically and instantly transfer to other equipment in the cluster. Additionally, the production environment is preferably supported by clustered, fully redundant database servers. Preferably, these systems will also be supported by a heartbeat connection between them. The entire contents of the advanced messaging system 124's databases will preferably reside on both systems, once again ensuring constant availability to all users of the application.

All data exchange between the advanced messaging system 124 of the present invention and the financial institution 122 is considered to be sensitive, and will preferably be transmitted securely. The security method used will depend on the circumstances, but likely candidates are SSL, or a secure tunnel between participating organizations. The advanced messaging system 124 of the present invention also uses an authentication and authorization scheme to ensure that only legitimate messages and information are passed.

When passing a user and necessary information between systems, the advanced messaging system 124 of the present invention preferably uses a web-browsing interface. An example is passing the user from a financial institution web page to a vendor's web site for shopping. Several methods may be used to support the data exchange, including cookies, query strings, and form posts.

For interactive real time data exchange, the advanced messaging system 124 of the present invention preferably uses Web services. An example is when the financial institution 122 fetches linked account information from the advanced messaging system 124 of the present invention to display on the customer's account summary page. These web services are preferably structured to support the data requirements of the financial institution 122. Multiple web service requests may be required for any one transaction.

Redundant connections to the internet from separate providers preferably feed to redundant routers. Each router preferably has at least one independent internet connection, will exchange connection state information utilizing Boarder Gateway Protocol, version 4 (BGP4) with its respective provider. Preferably, the routers will additionally be connected together to ensure failover and facilitate BGP route table propagation.

Preferably, each physical computer system in the advanced messaging system's production model will have two or more network interface cards (NIC) installed. In addition, each NIC will preferably be connected to separate layer 2 devices (switches). In the event of NIC, network cable, cable end, or switch failure, the server or system will have the ability to find a secondary path to the network, and the internet.

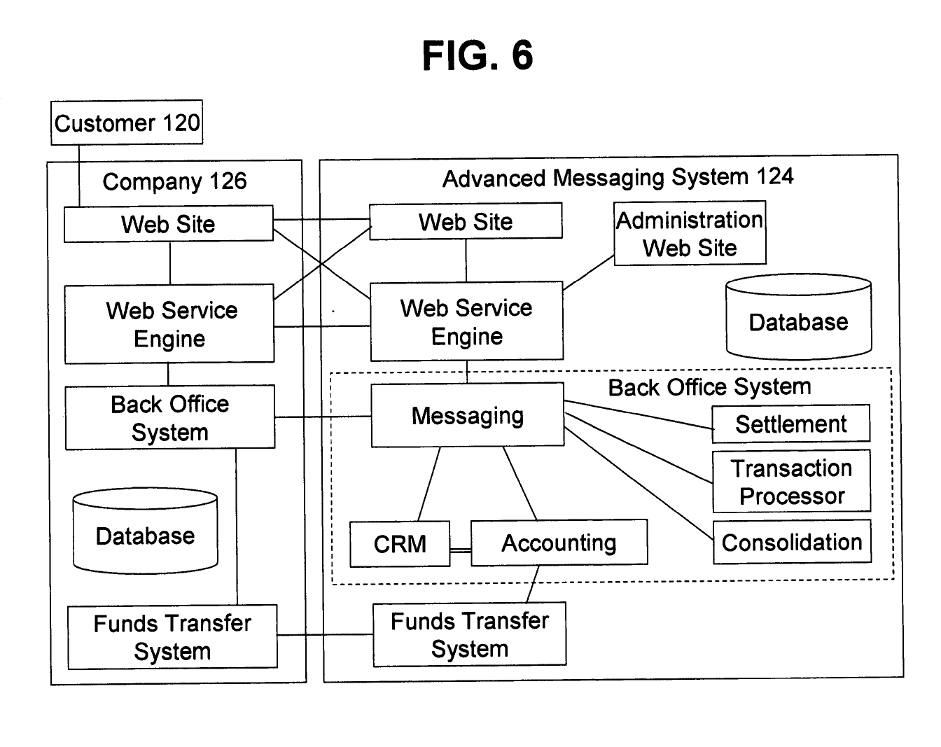

FIG. 6 depicts an advanced messaging system 124 designed to securely facilitate a wide variety of online payments: electronic funds transfers, electronic checks, credit cards, and purchase orders for goods purchased through a term loan. This advanced messaging system 124 is unique in that the database for account numbers may be maintained by the issuer of the credit card, debit card, or checking account for electronic checks and is not shared with vendors 128 for goods or services. Instead, one time unique transaction codes are recognized by the financial institution's system (acting as a payment issuer) to facilitate the financial transfer through the advanced messaging system 124. Separate unique transaction codes are recognized by vendors 128 to finalize the financial transfer. This also enables the end-user (e.g. customer 120) to securely link any online account, financial, or non-financial to his personal online financial institution's web page.

The advanced messaging system 124 of the present invention may use structured file messages for interactive real time data exchange and for exchanging batch data in the background. These messages can be structured to support the data requirements and format of the financial institution 122. Any protocol suitable for the financial institutions 122 may be used to transfer the files.

The advanced messaging system 124 as discussed above preferably maintains secure connections between itself and financial institutions 122, vendors 128, and any entity connected to the network. Further, the advanced messaging system 124 preferably identifies the customer 120 using information provided by a financial institution 122 or any entity connected to the network. The advanced messaging system 124 preferably also identifies financial institutions 122 and accounts for the identified customer 120 to select payment from, without knowledge of the actual account numbers but with enough information for the financial institution to identify the customer 120 and account. The advanced messaging system 124 preferably encrypts transaction control information on the network system for the purpose of later decrypting and using this information on the same system when a transaction passes through the system at a later time. Finally, the advanced messaging system 124 preferably completes the financing of the purchase between the vendor 128 and financial institution 122 on behalf of the customer 120: without the financial institution 122 knowing the selected vendor 128 or goods purchased; without the vendor 128 or the network knowing the number of the customer's account at the financial institution 122; and without the vendor 128 knowing the financial institution 122 from which the financing of the purchase is to be made.

### Loan Account

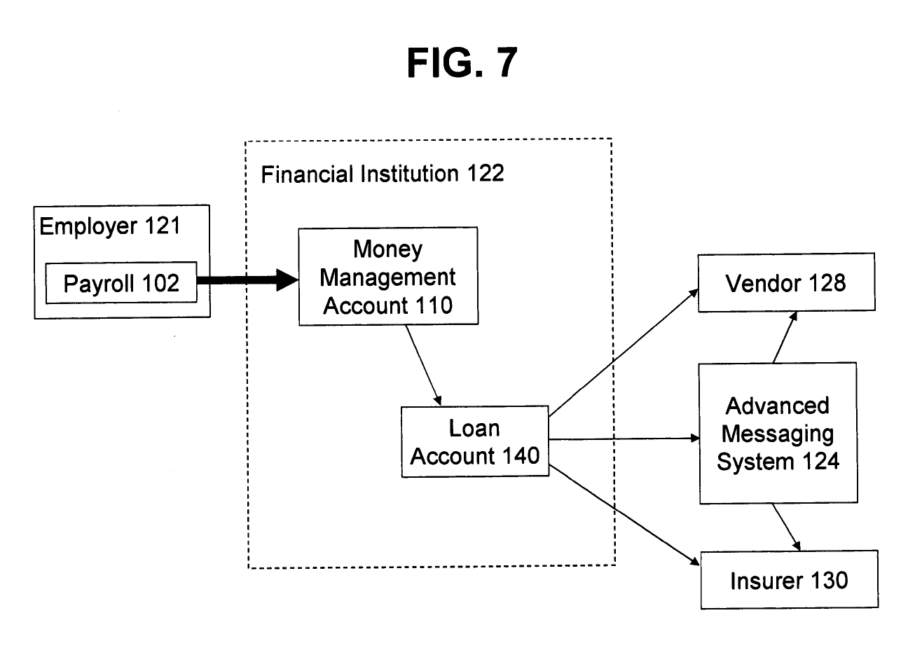

By using the loan account, a customer 120 (loan applicant) is able to obtain short-term loans to make purchases that he can afford, but before the advent of the present invention, might not have been able to make. Preferably, a loan account 140 is directly connected to the money management account 110 as shown in FIGS. 4 and 7. Repayment of any loans of the loan account 140 may be deposited/transferred directly from the money management account 110. In other words, repayment to the financial institution 122 (acting as a lender) may be handled as regular payments from the money management account 110. There are multiple methods of requesting a loan from a loan account 140, one of which is for an online purchase through a secure online shopping system (as described below). Funds obtained as a loan using the loan account 140 may be paid (deposited/transferred) directly to one or more payment recipients including the vendor 128, to an insurer 130 (if any), a credit card processor, to a facilitator of the purchase (e.g. an advanced messaging system 124 or administrator thereof), or to a combination of payment recipients. It should be noted that the vendor 128 may receive funds through the facilitator.

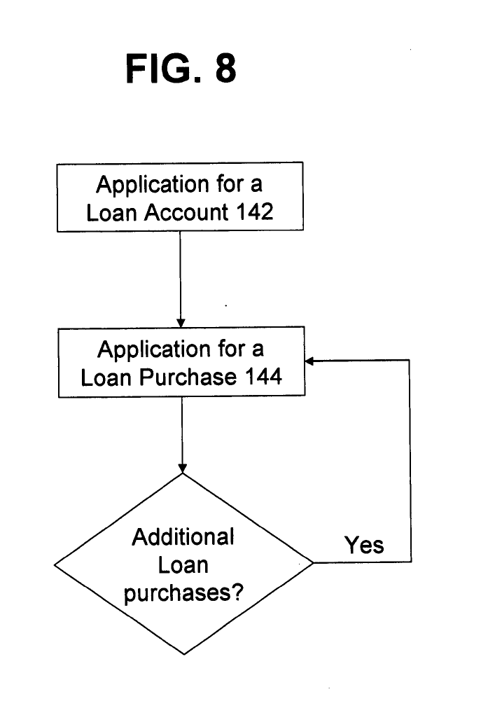

For the purpose of understanding the loan account of the present invention, the use of the loan account can be thought of in two separate steps shown in FIG. 8: application for a loan account 142 and application for one or more loan purchases 144. In practice, these steps may be performed together.

During the application for a loan account 142 the customer 120 is asked to supply or verify information typical to obtaining a loan such as name, address, phone number, and employment information. The application for the loan account 142 may also include the financial institution 122 requesting the customer 120 to supply additional information or verification documentation. Additional information or verification documentation may include photocopies of official documents, signed application forms, driver's license, and/or a social security card. During the application for the loan account 142, the loan account limit (the limit on total available financing) is also set. The loan account limit can be compared to the credit limit of a credit card. Up to the loan account limit, specific loans (for loan purchases) of any size are applied to the loan account 140. In one preferred embodiment, the loans are term loans (specific monthly/periodic payments for each loan to be re-paid in a set time period).

The loan account 140 may have associated insurance and/or deposit protection devices (also referred to as a credit-risk reducer) that are available for the financial institution 122 or customer 120 to cover loan losses. Further, in one preferred embodiment, the customer 120 must commit to maintain direct deposit to the financial institution 122 until the loan is repaid in full or face interest or other penalties to compensate the financial institution 122 for manual payment processing and/or reduced security of repayment of the loan.

The financial institution's approval, the loan account limit, and the amount of interest charged may be influenced by any combination of traditional factors (e.g. the customer's overall payment history, the customer's overall credit history, or his history with the specific financial institution 122) and factors specifically pertaining to the use of the present invention. Many of these factors were discussed in U.S. patent application Ser. No. 09/894,644. Factors pertaining to the use of the present invention include, but are not limited to the following factors:
The security provided by direct deposit of payroll (or other predictable payment systems) into the money management account 110.
The customer's work history.
The security provided by automatic and timely payments.
The presence of insurance and/or deposit protection devices.
The reduction of the financial institution's transaction processing costs.
The security of having the payment of loans prior to transfers to the discretionary fund account 112 (in other words, the financial institution 122 is assured of being in the first position to be repaid).
The customer's commitment to maintain direct deposit to the financial institution 122 (or other predictable payment systems) until the loan is repaid in full.
   Implementation of the loan account 140 makes smaller term loans economically feasible for lenders and borrowers. The loan account 140 also makes credit more universally available to individuals who work regardless of race or gender. It is possible that the loan account 140 may become the means to end economic segregation that is a very real part of American society today.

Application and approval for the loan account 140 may take place automatically at the time the customer 120 sets up his single source money management account 110, in a stand-alone operation/application to obtain a loan limit prior to purchasing goods or services, or as part of a specific purchase that requires a loan application. Approval for the loan account may not be immediate. While the loan account application is pending approval, individual loan applications requested by the customer 120 could result in a “preliminary approval” status.

The loan account 140 may contain multiple individual loans or may have multiple loans consolidated into a single loan at the request of the financial institution 122 or customer 120.

The second step in understanding the loan account 140 is the application for one or more loan purchases 144. An individual loan application for a loan purchase 144 is initiated by the customer 120 possibly through an online system similar to the secure internet shopping system described below. The intention of the loan account is that each individual application for a loan purchase 144 is an automated process for the financial institution 122, resulting in almost immediate processing, whether approved, declined or preliminary approval (authorization result).

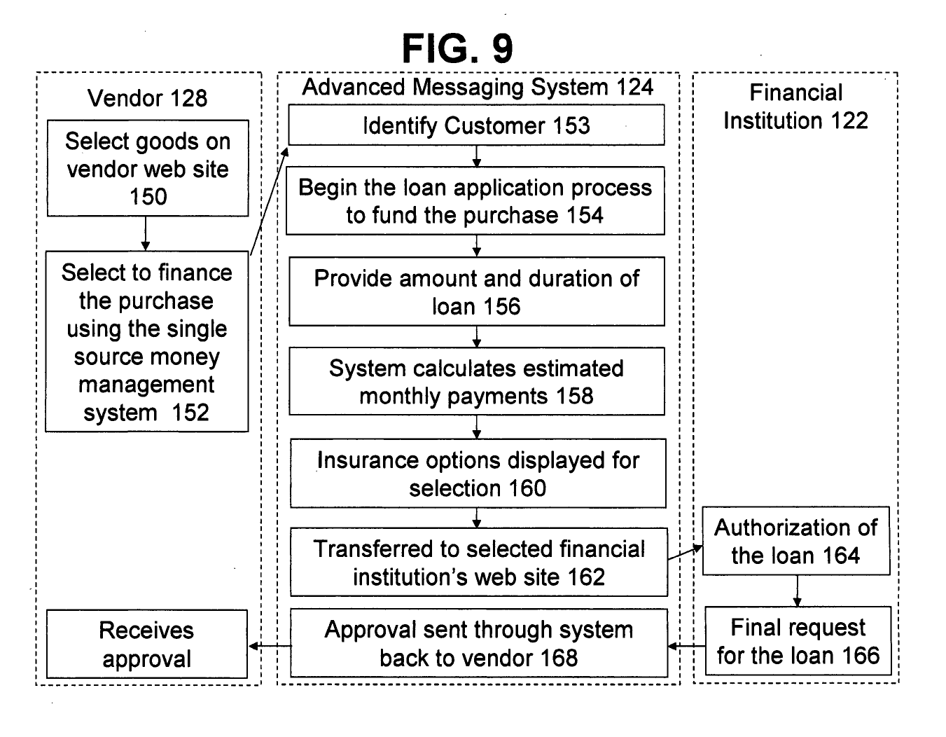

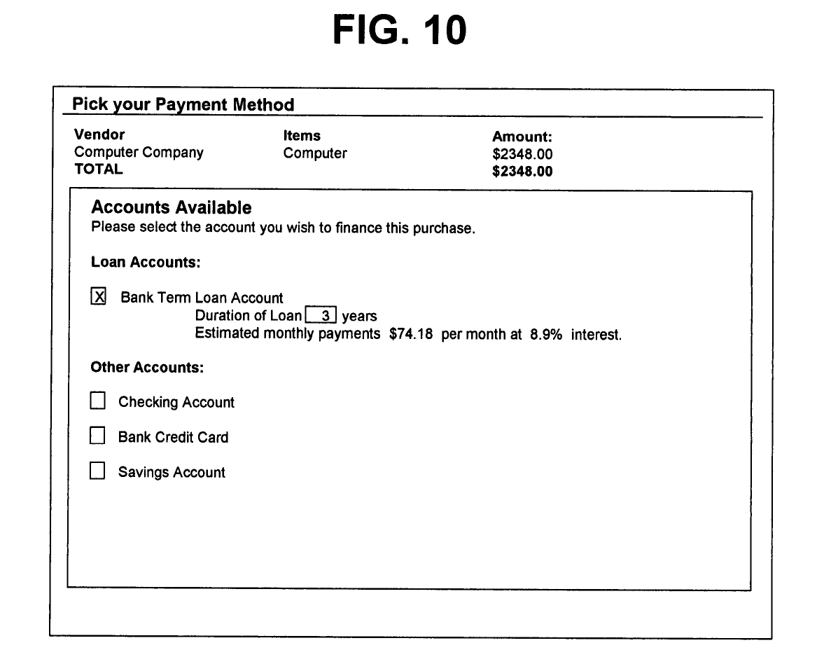

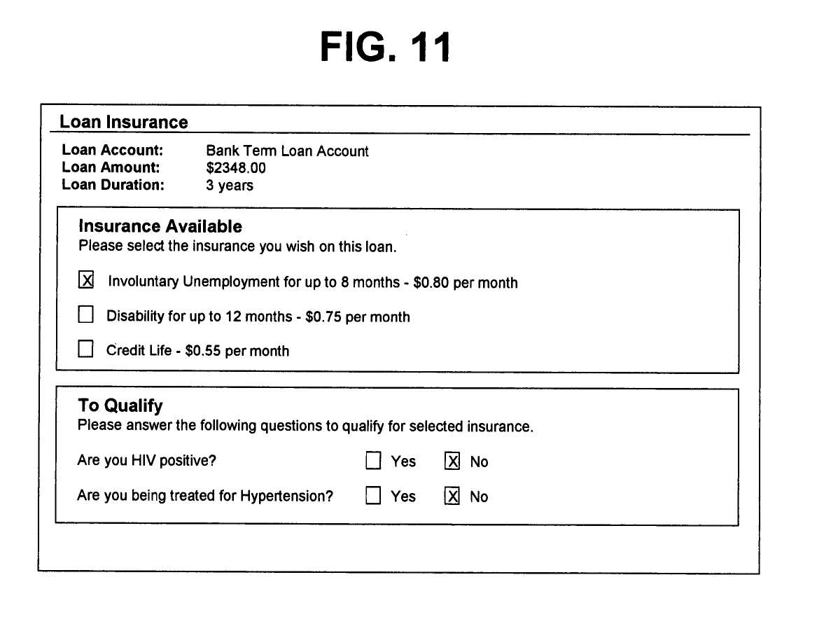

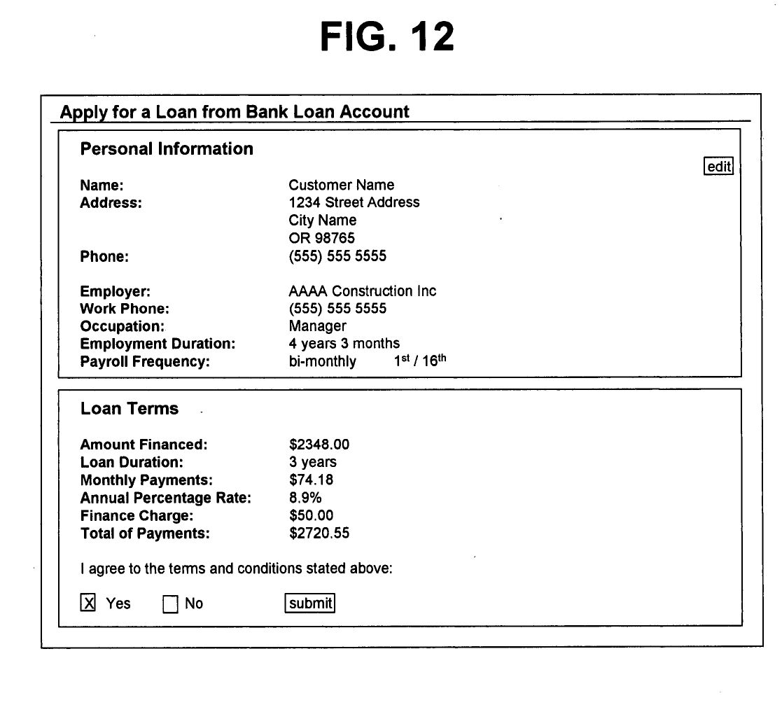

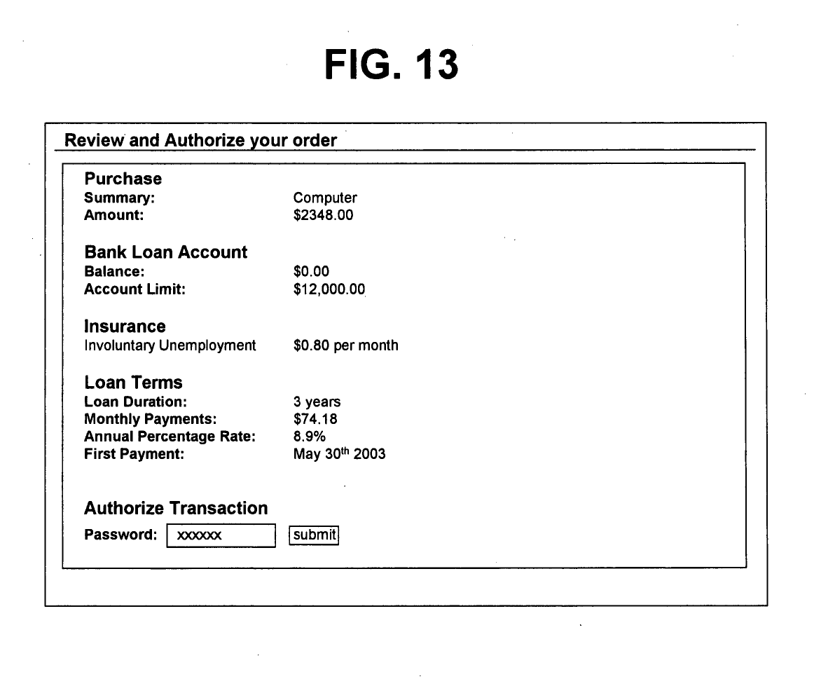

FIG. 9 shows an exemplary way that an application for a loan purchase 144 may work using the secure internet shopping system described below, where the customer 120 initiates the transaction on a vendor's web site. It is assumed that the customer 120 has already set up a money management account, the customer 120 has applied for and been approved for a loan account 142, and the customer's loan account 140 has sufficient available balance for the requested purchase. The customer 120 selects goods he wishes to purchase on the vendor's web site 150, and selects to finance the purchase using the single source money management system 152. The customer 120 is transferred to the secure internet shopping hub 148 where the customer 120 is preferably identified 153. If the customer has previously connected to the secure money management system he is immediately identified by the secure internet shopping hub 148. On the other hand, if the customer 120 cannot be immediately identified, he may be asked to log on to one of his financial institutions' web site where more information may be available or where the customer is identified as new (and is therefore prompted to register with the secure internet shopping hub 148). There are other ways for the customer 120 to identify himself. The customer 120 then begins the process of applying for a short-term loan to fund the purchase 154. From a payment method page such as that shown in FIG. 10, the customer 120 is preferably prompted to enter/select the amount of the desired loan (loan limit) and the desired duration of the loan (payment term) 156. The payment term may be, for example, anywhere from one to seventy-two months. In this example, because the customer 120 is in the process of making a purchase through the single source money management system, the desired loan amount may be pre-filled for the customer 120. The secure internet shopping hub 148 may then calculate the estimated monthly payments 158. For example, if the loan amount is $1000 and the duration is 55 weeks, the estimated weekly payments might be $20 (including the interest). From a loan insurance or member benefit page such as that shown in FIG. 11, the customer 120 may also be prompted to select a type of insurance if it is desired or required on this loan 160. In one preferred embodiment, insurance is provided free of charge for certain types of loans (e.g. for technological loans, student loans, first time loans, or loans above a certain amount). In another preferred embodiment, the cost of the insurance (insurance principal) is added to the amount of the loan (e.g. if the cost of the insurance is $50, the loan amount is increased by $50) and the insurance principal is transferred from the financial institution 122 directly to the insurer 130 upon completion of the loan, or indirectly (e.g. through the secure internet shopping hub 148). After the customer 120 agrees to the terms and conditions of the loan as displayed on a loan summary page such as that shown in FIG. 12, the customer 120 is transferred to the selected financial institution's web site 162. It is then the financial institution's responsibility to authorize the loan request by giving an authorization result of approval, a preliminary approval, or a denial 164. As mentioned above, the financial institution's approval may be based on traditional factors as well as factors specifically pertaining to the use of the present invention. If required, appropriate disclosures will be displayed to the customer 120. Preferably, a summary of the purchase and loan is displayed to the customer 120 (on a loan final approval page such as that shown in FIG. 13). At the loan final approval page, the customer 120 may be prompted to give final approval by providing a financial institution password or to cancel the loan application 166. The financial institution 122 may then initiate an automated repayment plan in the bill pay system 118, with repayments being made from the money management account. The customer 120 may then be transferred from the financial institution's web site to the secure internet shopping hub 148 with an approval code 168. The approval is then passed to the vendor 128. Payment for the goods preferably proceeds as described in the secure online shopping system section.

By using the loan account 140, a customer 120 has access to funds to facilitate purchases that before the advent of the present invention he might not have been able to facilitate. Using the figures from the simplistic example set forth above, an individual receives $1000 net pay (paycheck from payroll) 102 on a weekly basis that is deposited directly to his money management account 110. The customer 120 has monthly expenses including $2000 for rent, $300 for a car payment, $500 for utilities and cable, $100 for investments, and $100 for charitable donations. This individual might not be able to obtain a loan to buy a computer using traditional methods. Using the present invention, however, the customer 120 applies for a term loan online for a $1000 computer. The customer 120 requests a 55 week term loan. His own financial institution 122 approves him for the $1000 loan and charges a low rate interest for a total of $1100 to be paid off over 55 weeks ($20 a week). In other words, $20 a week is allocated for the loan account 140 for repayment of the loan. Even after the loan, every week the individual has $230 transferred from the money management account 110 to the discretionary fund account 112. The system of the present invention would handle all the details.

It should be noted that, if requested by the customer 120 (a setup process would ideally be performed), a loan account card may be issued that may be used for obtaining term loans or accessing the funds from the loan account. Alternatively, an existing credit or debit card may be enhanced with a loan account feature. Both the loan account card and the enhanced credit or debit card would allow the customer 120 to use the loan account 140 for purchases made outside the single source money management system (e.g. in a brick and mortar store).

The loan account 140 has similarities to known loan products such as systems in which cash advances are made on future paychecks and credit card-like products that are paid using payroll deductions. The loan account 140 of the present invention, is much more dignified (e.g. no groveling to the employer), more secure (e.g. no sensitive information is provided to unknown parties), and allows the customer 120 more freedom (e.g. in who may apply, what may be purchased, and the ease in each individual loan application) than those prior art loan products. In embodiments in which the loan account 140 is tied to the secure internet shopping system, the reduction in transaction costs and increase in security make the loan account 140 very profitable to financial institutions 122. Savings and security for the financial institutions 122 may result in lower interest rates to customers 120.

### Payroll Advance Account

A payroll advance account is a credit account in which the balance of the account is paid in full from the customer's next paycheck. This account is linked directly to the money management account 110 for automatic repayment. In practice the payroll advance account provides short-term credit available to the customer 120 with the advance loan limit being determined by the financial institution 122. The customer 120 may use funds from the payroll advance account for any purpose including making online purchases. Upon receipt of the next paycheck, loans obtained using a payroll advance account are automatically paid from the money management account 110 described above.

The payroll advance account may be an optional standalone feature of the present invention. The payroll advance account can also be incorporated into the loan account 140, where the term limit is set to “next paycheck.” Further, a payroll advance card may be issued that may be used for cash advances or purchases from the customer's next paycheck. Alternatively, an existing credit or debit card may be enhanced with a payroll advance feature.

The payroll advance account is different from employers 121 allowing employees to have a cash advance to be paid by the next paycheck. It is different from traditional “brick and mortar” institutions that allow payroll advances. It is different from online payroll advance services. Some exemplary differences and improvements that distinguish various embodiments of the payroll advance account from prior art include one or more of the following features:
Although the employer 121 may be the predictable payment source, the employer 121 may be completely functionally removed from the process of receiving a cash advance on future paychecks because the employer continues to simply deposit the entire paycheck into the employee/customer's money management account 110.
Privacy is protected because the employer 121 does not have to provide authorization for the cash advance or even realize that the cash advance has been made.
Privacy is protected because the employee/customer uses only his own financial institution 122, not a third party “brick and mortar” payroll advance institution or a third party online payroll advance services to which he would have to provide sensitive information.
After the initial application and set-up process, the process is substantially instantaneous and can be accomplished with the system of the present invention in which the entire process is fully automated.
A customer 120 does not have to venture into questionable “brick and mortar” payroll advance institutions that are often located in less than seemly geographic locations.
Payroll advances may be obtained repeatedly.
Depending on the advance loan limit set by the financial institution 122, any percentage of the employee/customer's paycheck can be advanced.
The repayment of the loan is fully automated from the customer's next paycheck.
Payroll advances become a convenience instead of an embarrassment.

Traditional financial institutions 122 have not chosen to offer payroll advance loans because of the risks associated with such loans. The financial institution's approval, the advance loan limit, and the amount of interest charged may be influenced by any combination of traditional factors (e.g. the customer's overall payment or credit history or his history with the specific financial institution 122) and factors specifically pertaining to the use of the present invention. Approval may take place automatically at the time the customer 120 sets up his single source money management account 110, in a stand-alone operation to obtain an advance loan limit prior to purchasing goods or services, or as part of a specific purchase that requires a loan request.

The payroll advance account has similarities to known loan products such as systems in which cash advances are made on future paychecks and credit card-like products that are paid using payroll deductions. The payroll advance account of the present invention, is much more dignified (e.g. no groveling to the employer 121) and allows the customer 120 more freedom (e.g. in who may apply and purchases that may be made) than those prior art loan products. In embodiments in which the payroll advance account is tied to the single source money management system, the reduction in transaction costs and increase in security make the payroll advance account a very profitable proposition to financial institutions 122. Savings and security for the financial institutions 122 may result in lower interest rates to customers 120.

Implementation of the payroll advance account makes payroll advances economically feasible for traditional financial institutions 122 and their customers 120. The payroll advance account also makes payroll advances more universally available to individuals who work regardless of race or gender.

It should be noted that this feature may be implemented on a fee basis such that customers 120 pay for each use of the feature and/or pay a single upfront additional fee to be allowed to use this feature (e.g. a premium membership). The fees charged may be influenced by any combination of traditional factors (e.g. the customer's overall payment or credit history or his history with the specific financial institution 122) and factors specifically pertaining to the use of the present invention. If fees are charged, the fees may be an additional factor that influences the financial institution's approval, the advance loan limit, and the amount of interest charged.

### Variable Bill Processing System

Variable bills are bills that vary on a regular basis. For example, a traditional telephone bill might have $30 of charges one month and the $150 of charges the next month, depending on the usage. Although many traditional variable bills are being phased out (e.g. calling programs for a flat fee are being used in place of traditional variable telephone bills), variable bills still exist and preferably can be handled by a bill pay system 118. Variable bills can be processed through the single source money management system, by using a bill processing hub 169 (which includes an advanced messaging system 124) for distributing the bills to the customer 120 and by using the customer's money management account 110 to pay the bills.

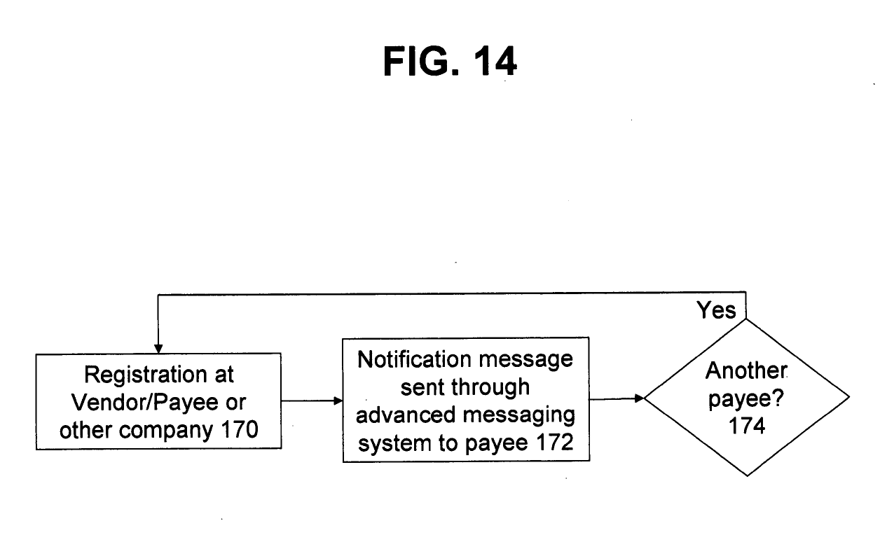

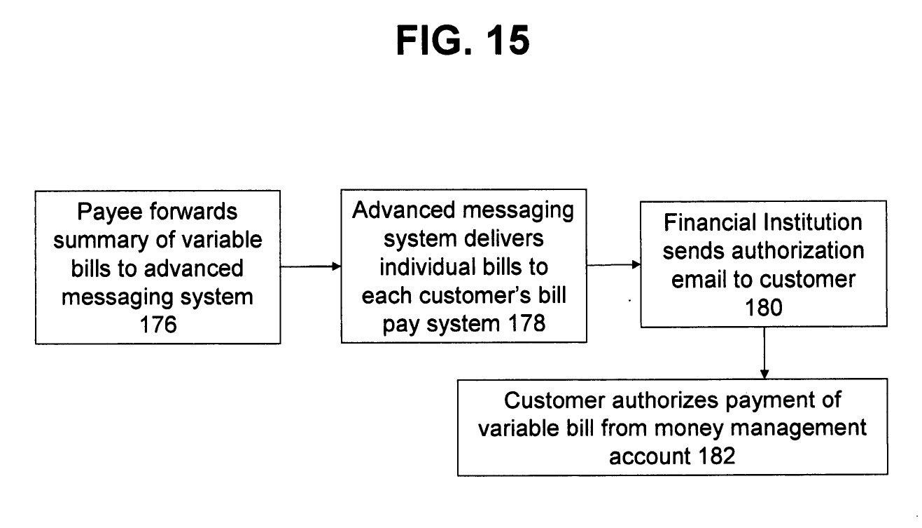

FIGS. 14 and 15 show one exemplary embodiment of how variable bill processing may be implemented using the single source money management system of the present invention. FIG. 14 shows the first step as a registration step 170 in which a customer 120 registers for variable bill processing for a specified payee 100 and provides relevant information to his financial institution's bill pay system 118 including identifying the payee 100 and the customer's payee account number. Although information relating to the customer 120 may be input by the customer 120, in one preferred embodiment, this information is pre-filled by the single source money management system and may be modified by the customer 120. In another preferred embodiment, the customer 120 may select the payee 100 by inputting an identifier of the payee that a bill processing hub 169 recognizes, with the bill processing hub 169 collecting and supplying appropriate payee information into the financial institution's bill pay system 118. Registration may include a payee notification step 172 in which the customer 120 or the single source money management system notifies the payee 100 that the customer 120 has registered for variable bill processing of the payee's bills. In a preferred embodiment, the customer 120 may be prompted to select optional payment instructions such as email notification, online authorization, automatic payment of bill amount, automatic payment of minimum due (e.g. on credit cards), automatic payment of bill up to specified amount. A combination of the optional payment instructions may also be available. For example, the customer 120 may select automatic payment up to specified amount, with email notification and online authorization if the bill is above that amount. The registration steps may be repeated 174 for each payee 100 for which a customer 120 wants to register for variable bill processing.

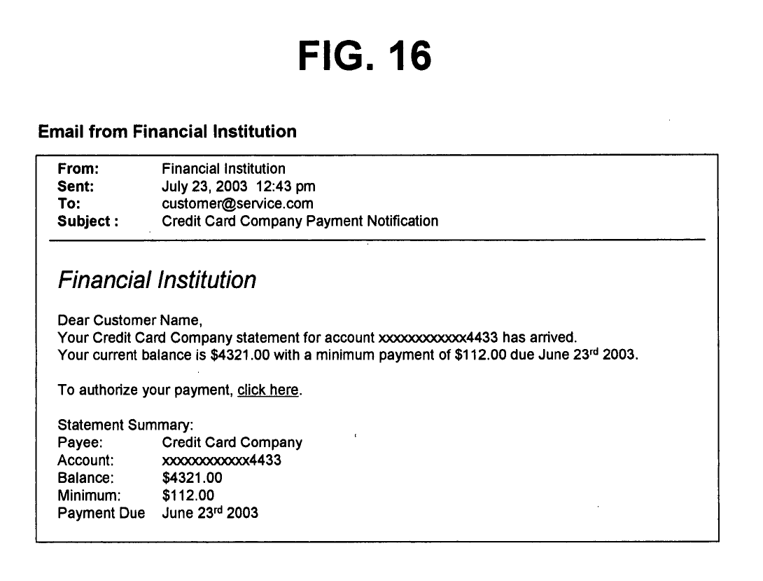

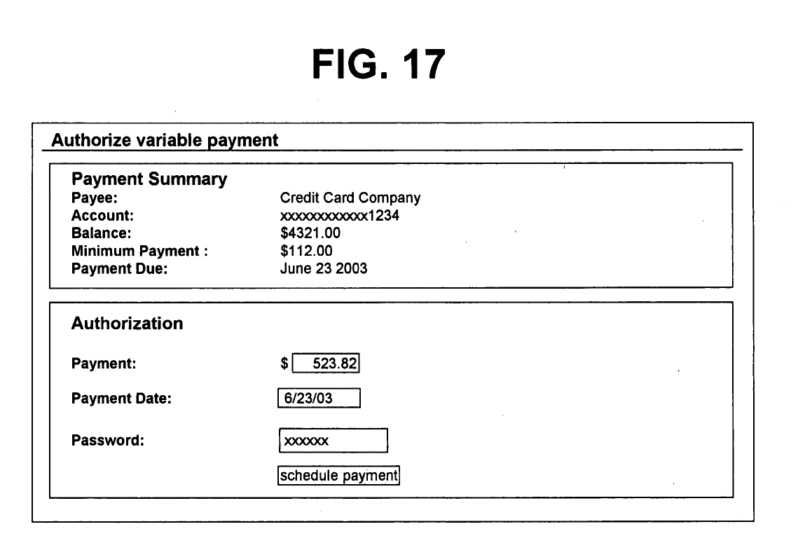

As shown in FIG. 15, each month (or other predetermined period) the payee 100 sends the bill processing hub 169 a request for payment list 176 of customer accounts from which payment is due and the amount of each customer's bill. This may be a list of only those customers 120 that have registered to have bill processing in this manner, or it could be a complete list of all customers of the payee 100. As the bill processing hub 169 knows each customer 120 that has registered for variable bill processing for this payee 100, and the financial institutions 122 from which the customers 120 pay their bills, the bill processing hub 169 forwards to each financial institution a consolidated list of customers and bill amounts for this payee 178. In one embodiment, the financial institution 122 would send an authorization email (FIG. 16) to each customer 120 with details of the bill and a link to an authorization page 180 (FIG. 17). The customer 120 goes to the financial institution's web page to authorize payment of his variable bill 182 and preferably arranges for the payment to be deducted from his money management account 110. Alternatively, the customer 120 could also have specified during registration a pre-approved bill amount limit or other type of limit (e.g. a total limitation for monthly variable bills or annual total limitation for a particular payee 100) that may be paid automatically from his money management account 110 without authorization. In this pre-approved embodiment, an authorization email would only be sent to the customer 120 if an individual bill and/or a total amount goes over the limit.

FIG. 3 shows an exemplary screen image of a screen that a customer 120 might use to schedule payments using the money management account 110. A variable payee could be indicated by checking a variable payee box. Payments that have been authorized or pre-approved would have the amount and send date filled in by the single source money management system. In one preferred embodiment, the user might be prompted with a pop-up window should the system detect that sufficient funds will not be available to cover anticipated expenses.

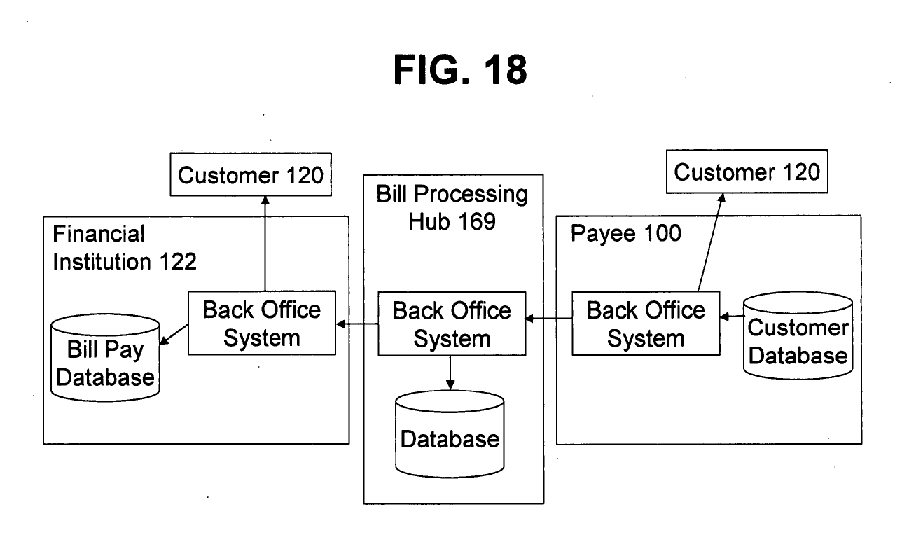

FIG. 18 shows one embodiment of exemplary system elements of the present invention used to implement the variable bill processing system. A payee 100 sends an electronic file containing a summary of its customers 120 and variable bill amounts to the bill processing hub 169. Using information from an associated database, the bill processing hub 169 sorts the customers 120 and groups the customers 120 according to their associated financial institutions 122. The bill processing hub 169 then sends an electronic message to each financial institution 122 with a summary of variable bills for the customers 120 of that financial institution 122. It should be noted that the bill processing hub 169 may group the customers 120 of multiple payees 100 (e.g. on a periodic basis) so that fewer summaries need to be sent to the financial institutions 122. The financial institution 122 updates its bill pay database to record the exact amount of each bill for each customer 120. As discussed above, the customer 120 may be given the opportunity to authorize individual payments or may have pre-arranged authorization.

### Secure Internet Shopping System

The single source money management system preferably includes a secure internet shopping system that allows customers 120 to purchase goods and services from online vendors 128. The hub of the secure internet shopping system (the secure internet shopping hub 148) may have at its core an advanced messaging system 124 as described earlier. Unlike conventional e-commerce sites, the secure internet shopping system does not transmit customers' account numbers over the Internet to vendors 128, nor does it require customers 120 to enter account information on the vendors' web site. In any data transmission involving the secure internet shopping system, the sender and receiver use an agreed-upon set of information that represents the customer 120 and/or order information. Only the financial institution 122 where the account resides has full access to the accounts and passwords of the customer 120. Security may be applied to messaging (e.g. encryption) to ensure integrity of the messages and verification of the source/destination of all messages between different entities within the secure internet shopping system.

An additional advantage to the secure internet shopping system of the present invention is that it simplifies the processing of financial transactions online, especially for vendors 128 who do not know from which account the payment is coming, and may not even know the type of account or the financial institution 122 from which the payment is coming. Payment may be made from any of the customer's accounts (e.g. checking, savings, brokerage, loan, payroll advance). It is even possible for the secure internet shopping system to process non-financial transactions (e.g. air miles). An additional advantage to vendors 128 is that they no longer have to process and provide security for sensitive financial information about the customer 120.

Although the secure internet shopping system is discussed in terms of an online shopping experience, this system may be carried out in traditional “brick and mortar” retail stores. An example of this is discussed in the internet ATM and POS transaction processing section below.

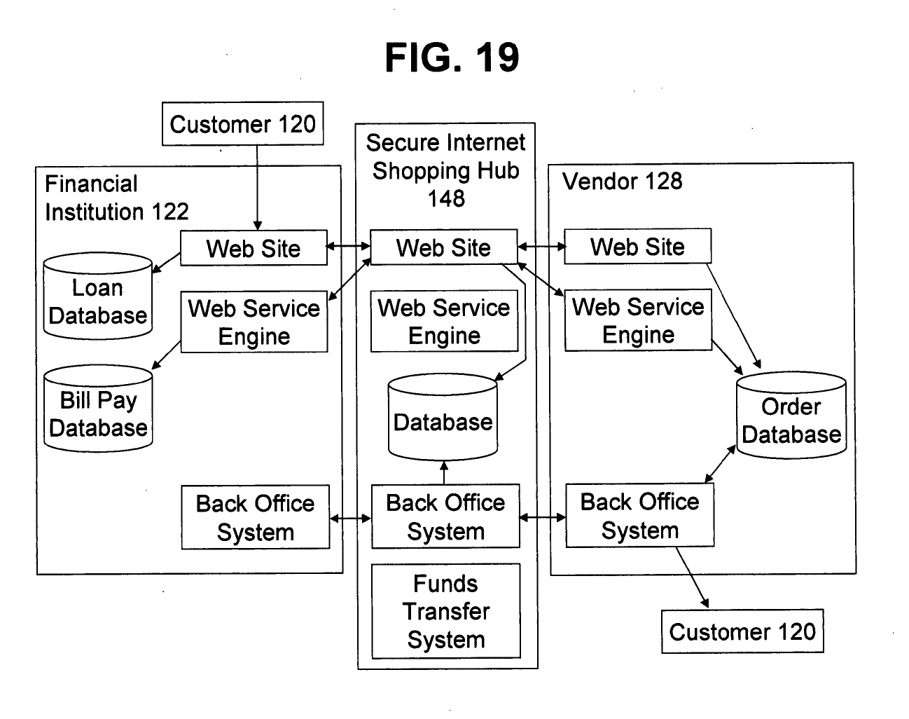

FIGS. 19, 20, 23, and 24 are schematic diagrams of exemplary system elements of the present invention used to implement a customer's purchase of goods, return of goods, and purchase of services. These diagrams are meant to be exemplary and alternate embodiments are possible.

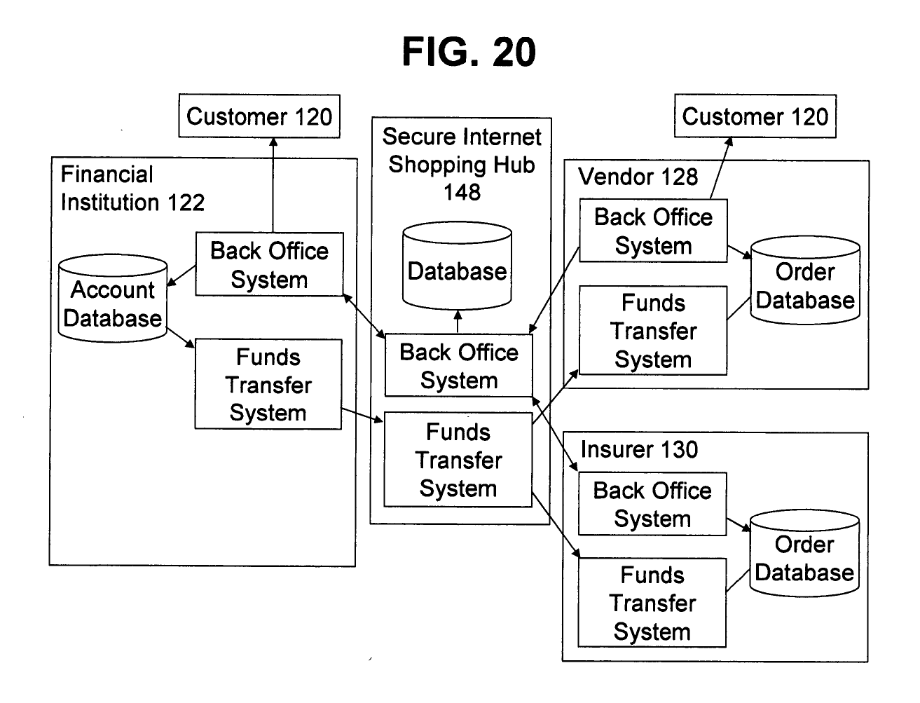

Turning first to FIGS. 19 and 20, a customer's purchase of goods is implemented in two parts.

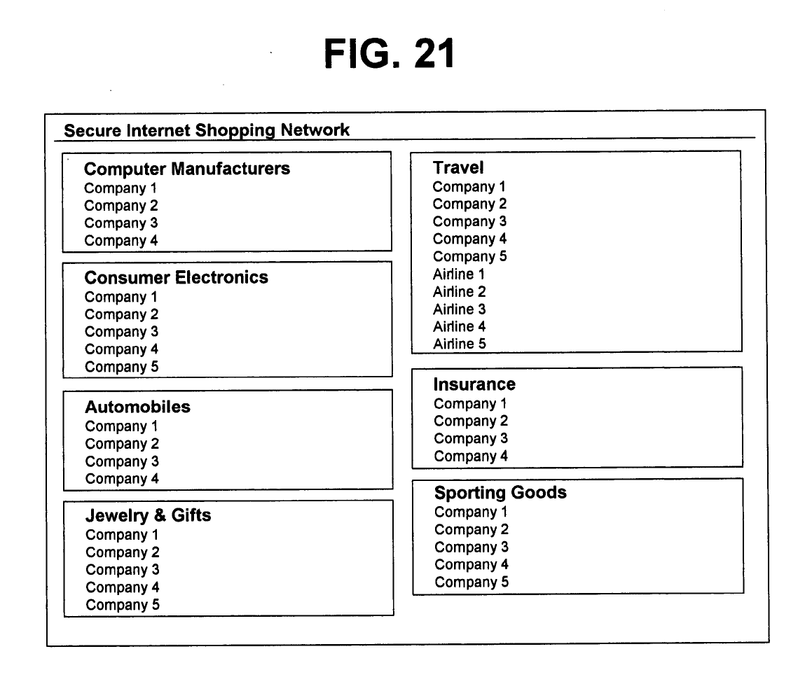

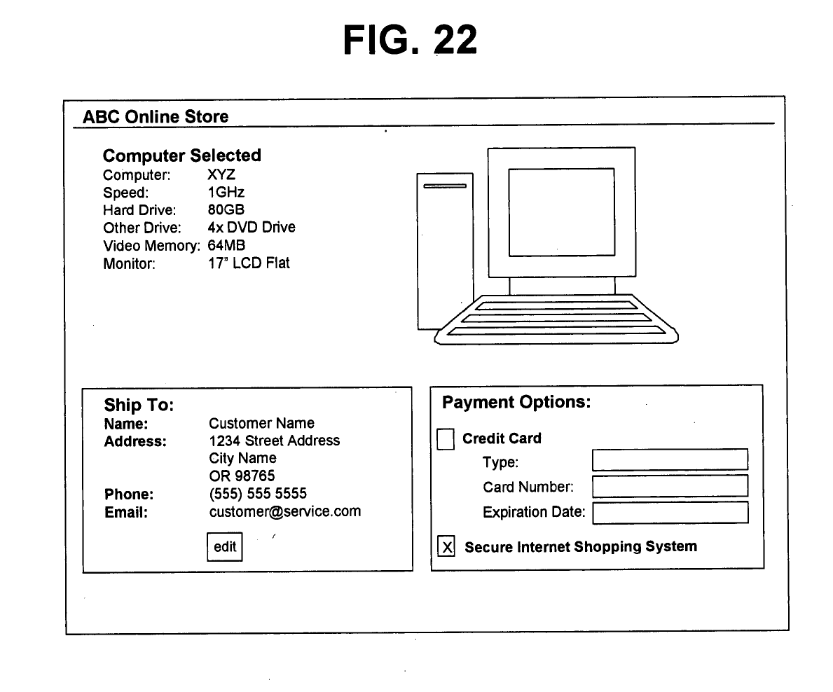

As shown in FIG. 19, the customer 120 first logs on to his financial institution's web site and requests/selects to go shopping. The financial institution web site transfers the customer 120 to the secure internet shopping hub web site (FIG. 21) where the customer 120 selects a vendor 128 associated with the secure internet shopping system. The secure internet shopping hub web site then transfers the customer 120 to the vendor's web site (FIG. 22). After the customer 120 selects goods, the vendor 128 retains the order in its database. When the customer 120 is ready to make a payment, the customer selects a payment method of the secure internet shopping system. The vendor web site then returns the customer 120 to the secure internet shopping hub web site. An optional feature of the secure internet shopping system is that it may attempt to up-sell goods to the customer 120. In one preferred embodiment, the customer 120 has the option to continue purchasing goods from other vendors 128 prior to arranging payment for purchased goods. The customer 120 selects an account (or multiple accounts) from which to make his payment for the goods (e.g. from a payment method page such as that shown in FIG. 10). In one preferred embodiment, the payment method page preferably shows a list of accounts from which the customer 120 may select the account(s) from which payment is to be derived. If a loan account 140 is selected as a payment method, the customer 120 selects the duration of the loan and, based on the amount and duration of the loan, the secure internet shopping system calculates the estimated monthly payments. In one preferred embodiment, the customer 120 is given the option to select the type of insurance required on this loan (e.g. at a loan insurance or member benefit page such as that shown in FIG. 11). In some alternative embodiments, the insurance is mandatory or is complementary for certain types of loans. The secure internet shopping hub 148 then transfers the customer 120 to the appropriate financial institution web site for authorization of payment. The financial institution 122 authorizes the transaction (providing an authorization result of approval, preliminary approval, or denial) for the purchase of goods against the selected account. If a loan account 140 is selected for payment, required disclosures may be displayed to the customer 120 (e.g. at a loan summary page such as that shown in FIG. 12). Preferably a summary of the transaction is displayed (e.g. at a loan final approval page such as that shown in FIG. 13) to the customer 120, before the customer 120 gives final approval by providing the financial institution password.

The financial institution web site then returns the customer 120 to the secure internet shopping hub web site with an authorization result (approval/preliminary approval/denial) and possibly with an approval code. If the transaction has been denied, the customer 120 may be given the opportunity to charge the purchase to another account. The secure internet shopping hub 148 updates the database. If automatic payment is required and has not already been initiated by the financial institution 122, the secure internet shopping hub 148 sends a web service automatic payment request to the financial institution 122. The financial institution web service adds automatic payment to its bill pay database and sends a confirmation response to the secure internet shopping hub 148. The secure internet shopping hub web site sends a web service order confirmation request to the vendor 128. The vendor's web service updates the order in its database and sends a response to the secure internet shopping hub 148. The vendor sends an email to the customer 120 confirming the order. The secure internet shopping hub web site then updates the order in its database. If approval also represents the purchase order from the financial institution 122, the back office system of the secure internet shopping hub 148 sends a purchase order request to the vendor 128, and sends an invoice to the financial institution 122 if necessary. If the transaction has been given preliminary approval from the financial institution 122, on final approval the financial institution 122 sends a purchase order request to the secure internet shopping hub 148. The secure internet shopping hub 148 then updates the database, sends a purchase order request to the vendor 128, and sends an invoice to the financial institution 122 if necessary.

When the vendor 128 receives the purchase order from the secure internet shopping hub 148 it updates the order in the vendor's database. The vendor 128 arranges for delivery of the goods to the customer 120 and sends an invoice to the secure internet shopping hub 148 (this may be an immediate message, a daily file, or a file sent at a predetermined interval or at specific times). The secure internet shopping hub 148 updates its database.

FIG. 20 deals with the second part of the purchase of goods, the payment for the goods. As shown, the vendor 128 delivers goods to the customer 120. The vendor sends a delivery notification to the secure internet shopping hub 148. The secure internet shopping hub 148 then updates the order in its database. If insurance has been purchased/provided for a particular purchase, the secure internet shopping hub 148 sends an insurance request to the insurer 130 (this may be a daily file). The secure internet shopping hub 148 sends a delivery notification request to the financial institution 122. The financial institution 122 then authorizes payment for goods and may send an email to the customer 120 pertaining to payment of funds for goods. When an insurer 130 receives an insurance request from the secure internet shopping hub 148 it updates its database and sends an insurance invoice to the secure internet shopping hub 148. The secure internet shopping hub 148 updates its database to include the insurance policy information. Once the financial institution 122 delivers funds and notification to the secure internet shopping hub 148, the secure internet shopping hub 148 delivers the funds and notification to the appropriate vendor 128 and insurer 130. Delivery of funds, notification of delivery and verification of receipt of funds all follow standard accounting practices. These standards may differ from company to company.

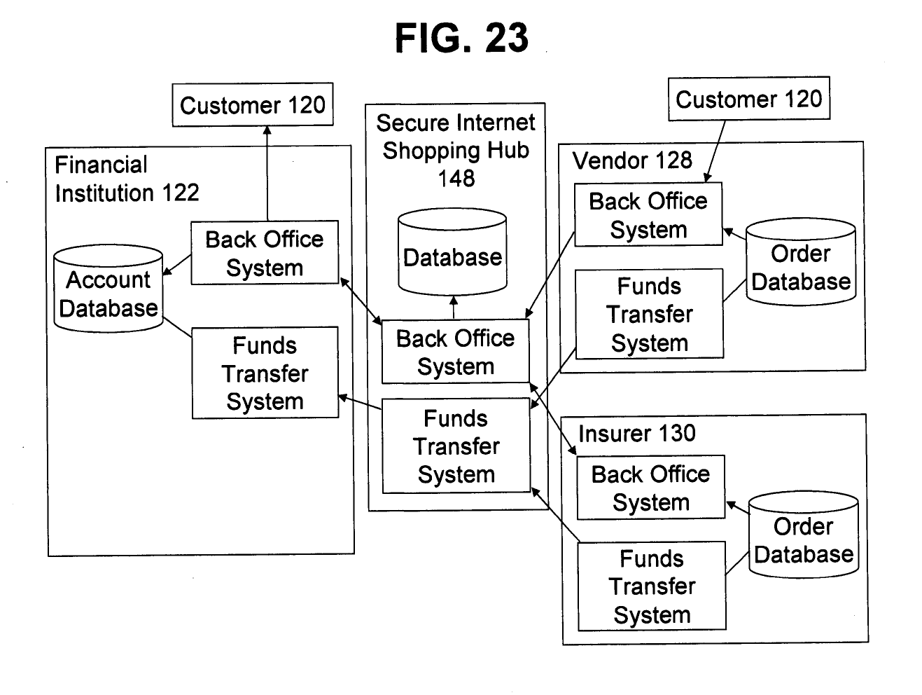

FIG. 23 shows exemplary system elements used to implement a return of goods. Specifically, FIG. 23 deals with when a customer 120 returns goods to the vendor 128 or does not accept the delivery. For the purpose of this example, it is assumed that the return happens after the vendor 128 has sent an invoice to the secure internet shopping hub 148 and received payment therefrom. Upon the return of goods to the vendor 128, the vendor 128 sends a goods delivery cancellation/update (providing notification that goods have been returned) to the secure internet shopping hub 148. It should be noted that an invoice cancellation/update (providing notification for accounting purposes of the change in funds to be charged/refunded) may be sent to the secure internet shopping hub 148 alone or in combination with the goods delivery cancellation/update. If the return is an “update” (only a partial order is returned), the secure internet shopping hub 148 determines new order information and updates the database to reflect the changes. If the return is a “cancellation” (an entire order is returned), the secure internet shopping hub 148 updates the database to reflect the return of goods. If insurance has been purchased or provided for this transaction, the secure internet shopping hub 148 sends an insurance cancellation/update request to the insurer 130 and the insurer 130 repays the funds to the entity that funded the insurance. It is possible that the insurance may be only partially refundable, nonrefundable, or nonrefundable after a predetermined period of time, in which case only the appropriate amount of insurance repayment would be available. The secure internet shopping hub 148 also sends the goods delivery cancellation/update (or a variation thereof) to the financial institution 122. When the vendor 128 returns the funds for the purchase to the secure internet shopping hub 148, the secure internet shopping hub 148 returns appropriate funds to the financial institution 122. If automatic payment is being used to repay a loan used for this purchase, the secure internet shopping hub 148 sends a web service automatic payment request (which in this case reflects a cancellation or update) to the financial institution 122. (If the secure internet shopping hub 148 is aware that the financial institution 122 has already modified the automatic payment to reflect the return, the secure internet shopping hub 148 could forgo sending the web service automatic payment request.) If it has not already done so, the financial institution 122 modifies the automatic payment to reflect the return.

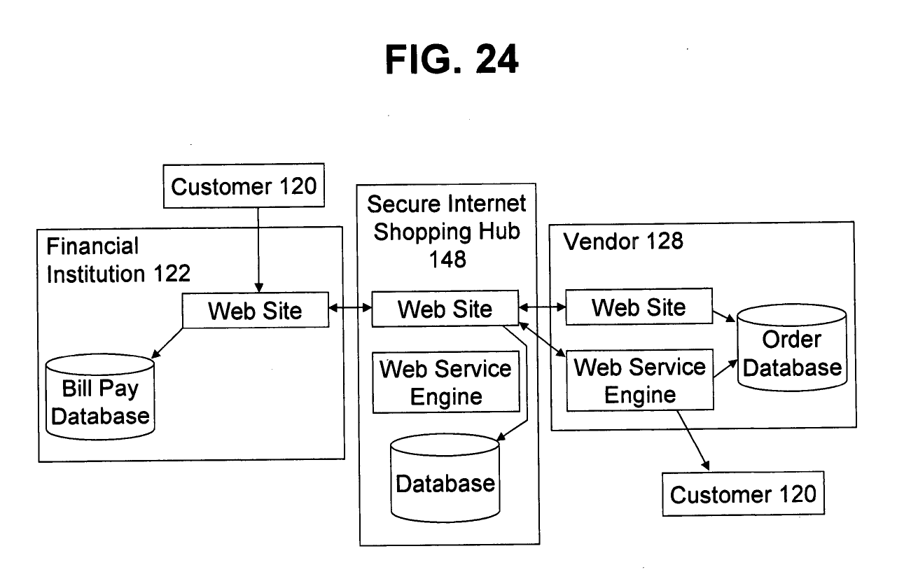

FIG. 24 shows exemplary system elements used to implement a customer's purchase of services. As shown, the customer 120 logs onto the financial institution web site and requests/selects to go shopping. The financial institution web site transfers the customer 120 to the secure internet shopping hub web site. The customer 120 then selects a vendor 128 from the secure internet shopping hub web site and is transferred to the selected vendor web site. At the selected vendor web site, the customer 120 selects his desired services. The vendor web site then returns the customer 120 to the secure internet shopping hub web site. The secure internet shopping hub web site then transfers the customer 120 to the financial institution web site. The financial institution web site sets up an automatic payment for the required amount to this vendor 128 (the vendor 128 is now also a payee 100). The financial institution web site then returns the customer 120 to the secure internet shopping hub web site where the automatic payment status in the database is updated. The secure internet shopping hub 148 sends a web service order confirmation request to the vendor 128. The vendor web service updates the order in its database and sends a response to the secure internet shopping hub 148. The vendor 128 sends an email to the customer 120 confirming the service order. The secure internet shopping hub web site then updates the order in its database. The customer 120 may then continue shopping on the secure internet shopping hub web site.

### Secure Online Collection of Sensitive Information

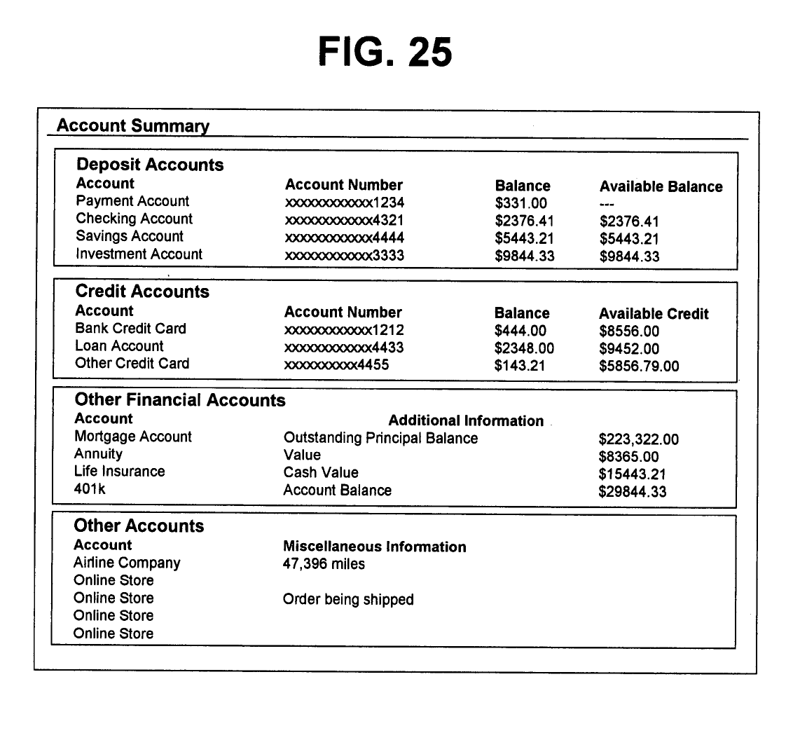

One embodiment of the single source money management system includes a system for secure online collection of sensitive information. The secure online collection of sensitive information is a secure method of collecting sensitive information using an information collection hub 188 (which may include an advanced messaging system 124) from various sources (e.g. web sites requiring security means such as identification codes and passwords), and displaying the sensitive information in a manner of the customer's choice (e.g. on a single secure web site/page). There are two steps to the secure online collection of sensitive information. The first step is the linking of sources of information. The second step is collecting and displaying this information in an account summary such as that shown in FIG. 25.

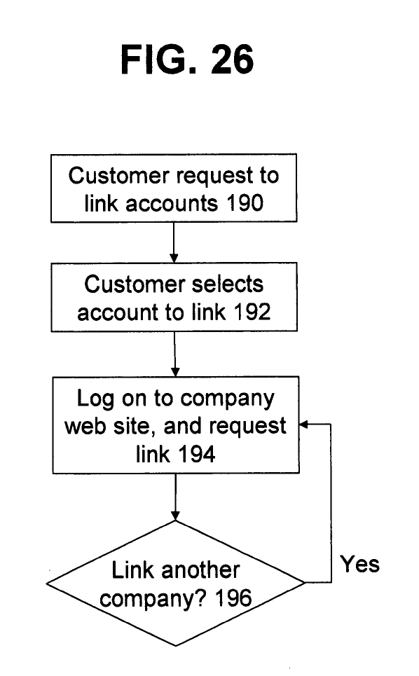

FIG. 26 shows one exemplary embodiment of a method for linking sources of information. A customer 120 may log on and connect to the network through his financial institution's web site (the display site). The customer first requests to link a new source of information to his financial institution's web site 190. The customer 120 then selects the source of an account that the customer 120 wishes to connect 192 which he is a member (e.g. AMAZON.COM®, AMERICAN EXPRESS®, AMERICAN AIRLINES®) (the collectee). The customer 120 may then log on to the company's web site and request a link to the network 194. The information collection hub 188 then links the customer identifier of the financial institution 122 with the customer identifier of the collectee, and maintains this link. The customer 120 may then link another account 196.

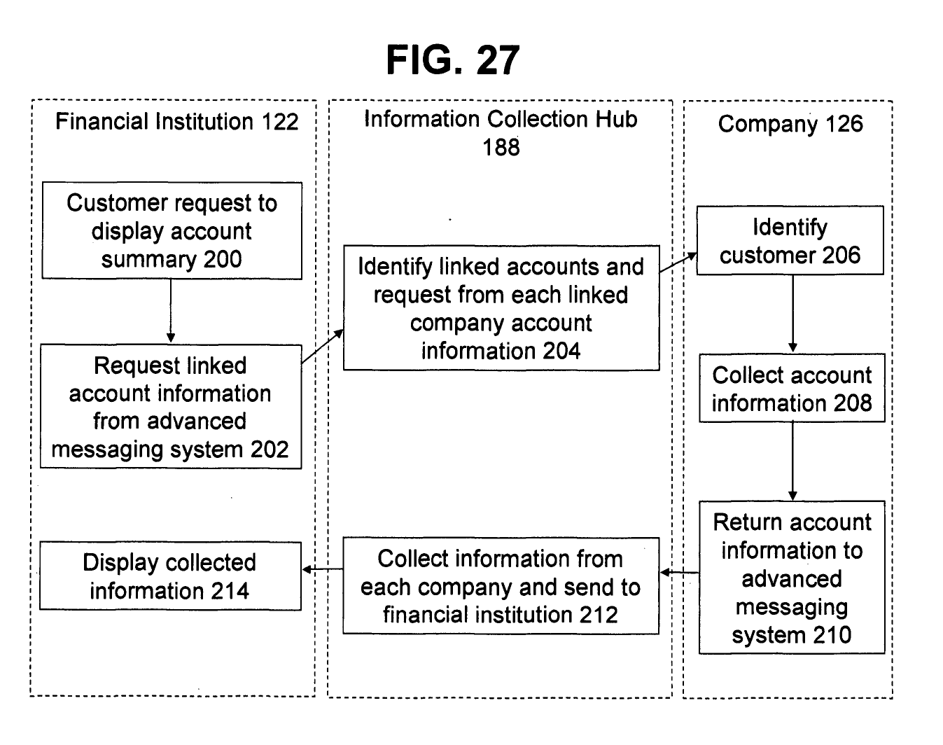

FIG. 27 shows one exemplary embodiment of a system used for displaying information. When summary information is requested by the customer 120 on the display site 200, the display site requests this information 202 of the information collection hub 188. The information collection hub 188 identifies all linked accounts, and requests summary information from each collectee 204. Each collectee identifies the linked account 206, collects information about the account 208, and returns collected information 210 to the information collection hub 188 (this is part of the license agreement for a company/individual to link to the single source money management system). The information collection hub 188 collects returned account information and passes this information on to the display site to be displayed 214. The secure online collection of sensitive information system is secure because neither site knows the customer's password for the other's web site (neither does the single source money management system), limited information (as determined by the customer 120) is returned about the customer's accounts (that information is displayed on a secure web site), and transmittal of secure information is through secure connections between the two sites through the information collection hub 188.

The secure online collection of sensitive information system of the present invention is different from known systems such as that described in U.S. Pat. No. 6,199,077 entitled Server-Side Web Summary Generation And Presentation (the '077 reference). The '077 reference describes a system in which a customer 120 gives identification numbers and passwords associated with the web site from which information is desired (the collectee site) to a system that is to collect this information (the collector). The collector then logs onto the collectee site as the customer 120, collects the information, and delivers this collected information to a site that displays it for the customer 120. Giving identification codes and passwords associated with the collectee site to the collector is a major security risk. Although the secure online collection of sensitive information system of the present invention is preferably used with the single source money management system, it should be noted that alternate methods may be used to collect sensitive information. Accordingly, the disclosure of the '077 reference is hereby incorporated herein by reference

### Internet ATM and POS Transaction Processing

In this aspect of the invention, ATM and POS networks are directly connected to the single source money management system, thereby becoming an extension to the single source money management system. In other words, ATM and POS networks will both display content provided by the single source money management system and accept input into the single source money management system. This is significant because ATM and POS device locations are generally located at vendors' locations. The vendors 128 are then able to connect (using, for example, dial-up, cable, or satellite connections) directly to the single source money management system, and are thus connected to any financial institution 122 licensed to the single source money management system. Possible information transmitted between the financial institution 122 and the ATM or POS through the single source money management system might include, but are not limited to screen information, questions for the customer 120, accounts available, balances, and digital signatures.

One example of this aspect of the invention might be where a customer 120 enters his single source money management system identification code or swipes his single source money management system card at an ATM/POS terminal located at the vendor's “brick and mortar” site. The customer 120 may then be required to input security information such as his single source money management system password. The customer 120 may then select his account he desires to use (e.g., “Bob's BANK CREDIT CARD account”) for a purchase or withdrawal. The single source money management system authorizes the transaction with the appropriate financial institution 122, without the vendor 128, or the single source money management system, knowing the customer's account numbers or passwords.

### Payee Self-Registration for Automatic Payment

Any individual or a company can self-register to be a payee 100 of the single source money management system. The individual or company may register in such a manner that it is not visible to the entire system (private registration). If the individual or company chooses private registration, it could pass the necessary information only to entities that it desires to have it. The private registration option would be particularly attractive if a payee only anticipated a limited number of clients (e.g. a homeowner who wants to allow a limited number tenants to pay his rent through the system). On the other hand, the individual or company can register in such a manner that it is visible to the entire system (global registration which is described below in the Payee Registration Throughout Network section).

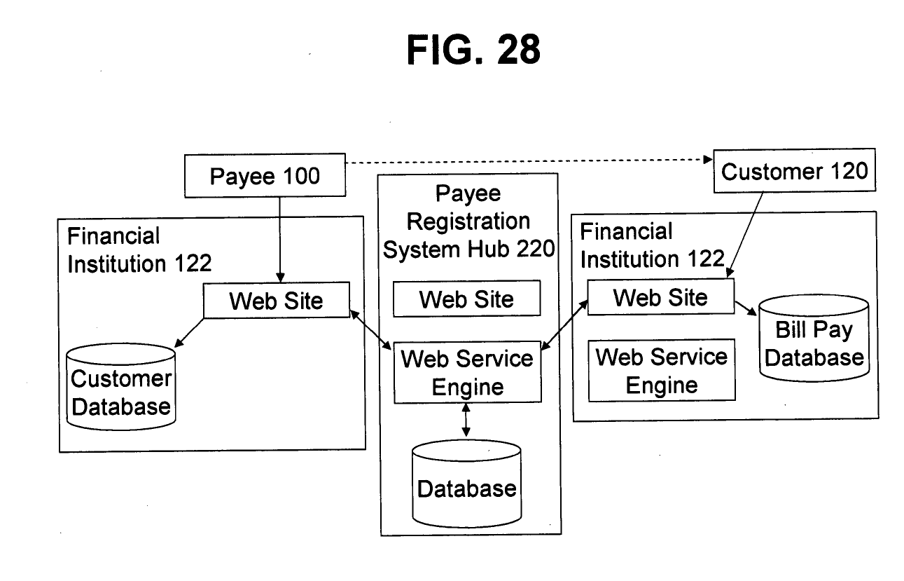

FIG. 28 shows exemplary system elements that may be used when an individual or a company self-registers to be a payee 100 of the single source money management system. The payee 100 logs on to his financial institution's web site and requests to be a payee in the single source money management system. The financial institution 122 sends a payee request message to the payee registration hub 220, with information about the payee (e.g. payee name, bank routing number and account information). The payee registration hub 220 responds with a payee identification code that the financial institution 122 saves in its customer database and provides to the payee 100. The payee identification code can safely be given to a potential customer 120 who wants to set up an automatic (or one time) payment to the payee 100. The customer 120 then inputs this payee identification code into his own financial institution's bill pay system 118 (the customer 120 and payee 100 can be at the same financial institution 122 or at different financial institutions 122). The financial institution 122 requests payee information (e.g. payee name, bank routing number and account information) from the payee registration system hub. The customer 120 can then verify the correct payee identification code has been entered by verifying that the resultant name (the name displayed to the customer that is associated with the identification code) of the payee 100 is correct. Preferably, this registration process is a fully automated process.

This is significant because bank/account information is not passed to the customer 120. The payee 100 is not required to provide bank/account information to the customer 120, and the customer 120 is not required to enter this information accurately into his financial institution's bill pay system 118.

### Payee Registration Throughout Network

One embodiment of the single source money management system includes a payee registration system, a system for a payee 100 to globally register throughout the single source money management system. A payee 100 that may already be privately registered (see the Payee Self-Registration for Automatic Payment section above) can request to be registered throughout the network of financial institution's bill pay systems 118. A globally registered payee 100 only has to register once. The payee registration system then automatically adds the payee 100 to every financial institution's bill pay system 118, or a selection of financial institutions 122 determined by the payee. Updates made to the payee information are similarly global and automated.

It should be noted that each financial institution 122 may charge a fee to entities registered as a payee 100 in their system. This would limit the number of payees 100 who choose global registration. Entities that did not want to incur this expense could opt for private registration.

### Customer Updates Permeate Through Network

Another advantage of the present invention is that a customer 120 registered with the single source money management system only has to register once and make any changes to one of his accounts.

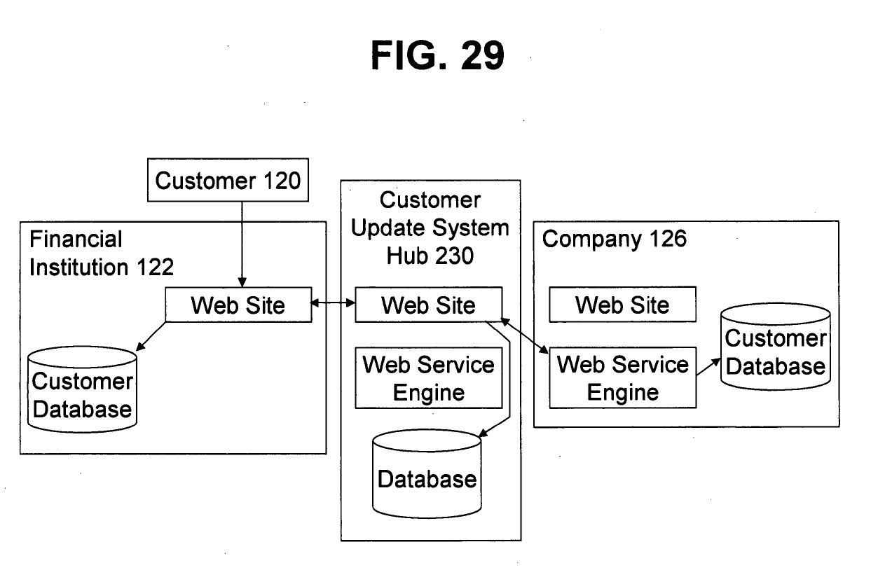

FIG. 29 shows exemplary system elements that may be used when the customer 120 makes a profile update on one of his accounts that permeates through the single source money management system. The customer updates his profile on his financial institution's web site. At the customer's request, the financial institution 122 passes the customer 120 to the customer update system hub 230. The customer 120 then identifies which of his previously linked accounts he wishes to update with his updated profile, and the customer update system hub 230 transmits and receives verification of each customer update from each company 126 hosting selected linked accounts.

This relieves customers 120 of the burdensome task of having to update multiple accounts every time a change is made to their information. For financial institutions 122, vendors 128, payees 100, and other companies connected to the single source money management system, this also helps to insure that customer information is accurate and up to date.

### Customer Registration

A customer 120 registering to the single source money management system through his financial institution web site may conduct business including, but not limited to applying for and/or accessing a money management account 110, applying for and/or accessing a loan account 140, using the secure internet shopping system, linking accounts to his financial institution account summary web page, updating customer information throughout the network, registering to be a payee 100 or updating information pertaining to a payee 100, and/or registering for or accessing other financial institution services.

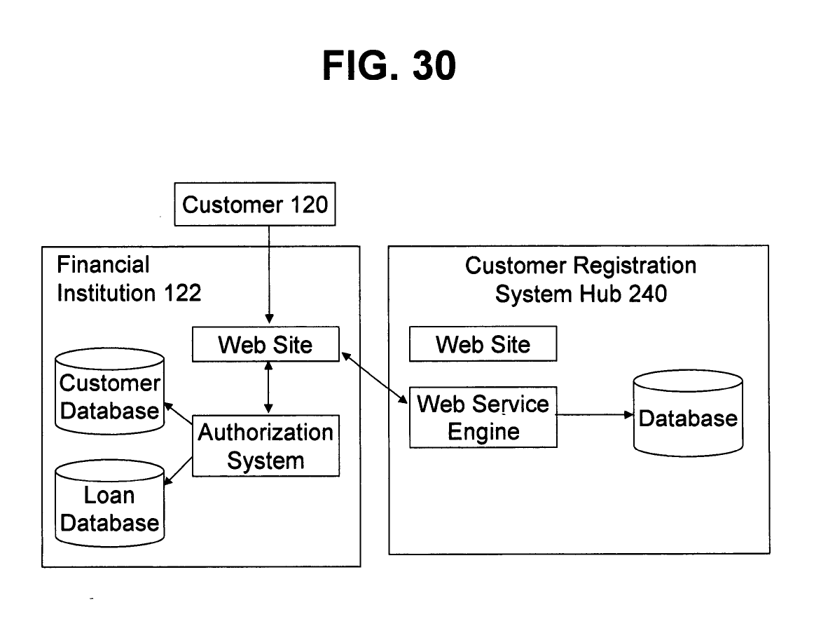

FIG. 30 shows a schematic diagram of an exemplary customer registration system that could be used by a customer 120 to register with the single source money management system of the present invention through a financial institution 122. For the purpose of this example, the customer 120 selects the option of registering for both a money management account 110 and a loan account 140. The financial institution web site sends the customer request (to add the accounts) to the customer registration system hub 240. Generally, customer information (e.g. name, address, email, the financial institution 122, the customer identification, and account names (e.g. checking, credit, loan, brokerage, savings)) is provided automatically by the financial institution 122. The financial institution's web site may, however, prompt the customer 120 to provide additional and/or missing information (e.g. information about his direct deposits, including the frequency and the date of the next occurrence of the direct deposit), confirm and/or verify information, or supply supporting documentation. The customer registration system hub 240 then adds the customer information to the database. The customer registration system hub 240 then sends a confirmation response to the financial institution 122 that includes a customer identifier that the financial institution 122 may or may not decide to retain and use in future communication between the financial institution 122 and other components of the single source money management system regarding this customer 120.

The financial institution 122 creates a money management account 110 by redirecting the customer's existing direct deposit from an existing account into the money management account 110. Alternatively, the financial institution 122 provides information to the customer 120 to enable him to redirect his paycheck into his money management account 110. If the customer 120 has not been pre-qualified for this account, the financial institution 122 will provide information to and/or receive information from the customer 120 in order to qualify. The financial institution 122 also requests and receives instructions from the customer 120 as to where to deposit/transfer the un-retained funds. The location of where the un-retained funds is deposited/transferred is the discretionary fund account 112.

The financial institution 122 may activate the customer's loan account 140, making it immediately available for use in online shopping. If the customer 120 has not been pre-qualified for this account, the financial institution 122 will provide information to the customer 120 in order to apply for this account.

The financial institution 122 sends the customer and account information to the customer registration system hub 240 and notifies the customer 120 that his accounts have been established (or the current status thereof).

In one preferred embodiment, the financial institution 122 pre-qualifies a customer 120 for a money management account 110 and/or a loan account 140. For example, suitable candidates for pre-qualification would be existing customers 120 with direct deposit of payroll or other equivalent predictable payment systems that deposit a sufficiently predictable dollar amount into an account with the financial institution 122 on a regular basis (e.g., a regular distribution from a retirement account). For customers 120 who do not currently have direct deposit of their income, the financial institution 122 may notify them of the availability of the service if they subsequently setup direct deposit. For customers 120 who indicate they are interested in establishing a money management account 110 and/or a loan account 140, the financial institution 122 is generally responsible for all decisions. For example, the financial institution 122 may determine whether or not to approve a loan account 140 and an individualized credit limit for each customer 120 using its chosen practices for credit application and approval (e.g. credit history within the financial institution 122 or an external credit authorizing company). The financial institution 122 may also make determinations based on factors specifically pertaining to the use of the present invention (discussed above).

### Miscellaneous

The present invention may be administrated by one or more individuals, one or more business entities, and/or one or more software programs that alone or in combination function as a single source money management system or administer a single source money management system. Although the system of the present invention has been discussed as including entities such as at least one customer, at least one financial institution, at least one predictable payment source, and/or at least one vendor, these entities may be external to the present invention. For example, the present invention may be a software program that uses or is used by an existing financial institution to implement the present invention. Steps carried out by the system such as administering, directing, monitoring, controlling, and facilitating may be carried out as described in this specification or by as would be known by one skilled in the art. For example, if a business entity “administers” the establishment of a money management account and/or discretionary fund account, it may be that the financial institution actually establishes the account(s) while the business entity requests the account(s) be established and verifies the establishment of the account(s).

It should be noted that the security means discussed herein are meant to be exemplary. For example, identification codes (e.g. an identification number), passwords, digital signatures, and other security means may be used interchangeably or in combination.

It should be noted that the term “money” is meant to include other valuable consideration including, but not limited to airline mileage, promotional points, tokens, coupons, and any other valuable consideration. For example, the present invention may include deposits of promotional points and the spending of those promotional points. On one alternative embodiment of the present invention, these alternative sources of valuable consideration may be maintained by a system outside the system maintained by the financial institution 122. It should be noted that the terms “direct deposit” and “payroll” are meant to be exemplary and should be considered as examples of other predictable payment systems that deposit a sufficiently predictable dollar amount into an account with the financial institution 122 on a regular basis (e.g., a regular distribution from a retirement account) or that provide adequate security (e.g. an extremely large balance on an account within the financial institution 122). It should be noted that the source of money from the predictable payment system may be any predictable payment source including but not limited to an employer 121.

It should be noted that the various entities discussed in this specification are meant to be exemplary. The various entities may “wear different hats” by functioning in multiple ways. For example, a financial institution 122 may function as a vendor of services. Another example is that the customer 120 may be a company or other business entity. Yet another example would be a business that functions as a financial institution 122 for purposes of this invention even if it is not a traditional financial institution (e.g. a credit card issuer that allows consumers to have accounts as set forth in the present specification or a standalone business that functions as a financial institution for the specific purpose of implementing the present invention). It should also be noted that additional entities (e.g. facilitators) may be added to entities discussed in the invention. For example when payment is made to a vendor the payment may flow through a facilitator such as a financial institution or an administrator. Another exemplary facilitator may be that when a financial institution makes a payment or receives a payment, additional intermediary facilitators may be used to complete the transaction. It should be noted that a customer 120 may be employed by more than one employer 121. Similarly, more than one person (e.g. a married couple) may be a single customer 120 that is referenced by the unique identification number.

It should be noted that technical terms such as “computer,” “email,” and “database,” are meant to be exemplary and do not limit the scope of the invention. For example, “email” may be replaced with a voice mail or instant messaging. As another example, a traditional computer may be any type of network terminal known or yet to be developed, a kiosk (e.g. one located at an employer's place of business or a vendor's place of business). Similarly, the terms “electronic communication media,” “internet,” and “web,” are meant to be broadly construed and may include alternative technologies including but not limited to the internet, the web, LANs, WANs, any electronic communication media, or any yet to be developed that allows communication could be used in place of a traditional computer.

For the purpose of consistency, in this application every attempt was made to use terminology consistently. It should be noted, however, that alternative embodiments are possible and are not excluded from the scope of the invention. For example, although many of the examples are discussed in terms of purchasing “goods,” it is possible that the same examples would work equally as well with “services.” Another example is that although the specification may specify that the “web site” (e.g. the financial institution web site) is performing a particular function, it may be possible that a separate program (e.g. a loan limit calculation program) or a living entity (e.g. a loan officer) could be performing the same function. Yet another example is that terms such as “deposit” and “transfer” may be used interchangeably if one skilled in the art would understand how to convert between the two (e.g. funds may be physically deposited or electronically transferred). Still another example is that alternate systems of the secure money management system may perform the functions specified (e.g. although it may be specified that the secure internet shopping hub performs the function, in alternate embodiments the advanced messaging system may actually perform that function).

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A network configured to permit at least one transaction and to include at least one transfer of funds, at least one customer and at least one vendor having access to the network, the network comprising:
at least one computerized advanced messaging system;
at least one financial institution systems, a financial institution being an entity that manages customer accounts containing some form of currency that can be transferred, the financial institution system linked to the advanced messaging system;
at least one vendor system, the vendor system linked to the advanced messaging system;
at a customer financial institution, there being customer account information associated with the financial institution and the customer, and the customer account information having a financial institution customer identifier;
at a vendor financial institution, there being vendor account information associated with the financial institution and the vendor, and the vendor account information having a financial institution vendor identifier;
wherein the network is configured such that at the customer financial institution, the customer can request the transmission of the financial institution customer identifier to the advanced messaging system, and wherein the financial institution customer identifier is transmitted to the advanced messaging system;
wherein the network is configured such that at the vendor financial institution, the vendor can request the transmission of the financial institution vendor identifier to the advanced messaging system, and wherein the financial institution vendor identifier is transmitted to the advanced messaging system;
wherein the network is configured such that a customer order can be created at the vendor system associated with the customer and the vendor, the customer order having an vendor customer order identifier, wherein the vendor customer order identifier is transmitted from the vendor system to the advanced messaging system, wherein within the advanced messaging system the advanced messaging system forms a connection between the vendor customer order and the financial institution vendor identifier;
wherein within the advanced messaging system, the customer can selectively link the financial institution customer identifier and vendor customer order identifier, thus forming a connection between the customer account information at the customer financial institution, the customer order at the vendor and the vendor account information at the vendor financial institution, such that at least one transaction involving the customer financial institution, the vendor financial institution, the customer and the vendor is permitted; and,
wherein a transfer of funds can take place between at least one selected customer account at the customer financial institution and the vendor account at the vendor financial institution.

2. The network of claim 1 wherein the financial institution can be at least one of the following:
a Bank;
a Credit Union;
a Building Society;
a Government;
an Employer, where the currency is something of value that can be built up over time and has value, for example hours of overtime;
an Airline, where the currency is frequent flier miles;
a Retailer, where the currency is frequent buyer points; and,
an other entity, where the currency can be transferred.

3. The network of claim 1 wherein the customer financial institution and the vendor financial institution are the same financial institution.

4. The network of claim 1 wherein the vendor customer order identifier is a vendor customer identifier associated with multiple customer orders within the vendor system.

5. The network of claim 1 wherein the network is configured to permit at least one transaction from a first information source to a second information source such that:
at the first information source the customer can request the delivery of selected information to the advanced messaging system associated with a first associated identifier;
at the second information source the customer can request the receipt of the selected information from the advanced messaging system associated with a second associated identifier;
wherein, within the first information source, the selected information is transmitted to the advanced messaging system such that the selected information is associated with the first identifier, the first information source transmits the selected information to the advanced messaging system on occurrence of at least one of the following:
(i) on the customer request of delivery of selected information;
(ii) on receipt of request from the advanced messaging system for delivery of selected information;
(iii) at a specific date/time as determined by the first information source and/or the advanced messaging system; and,
(iv) other event as determine by the first information source and/or the advanced messaging system;
wherein, within the advanced messaging system, the second information source is identified as a destination for the selected information, wherein the selected information is transmitted to the second information source associated with the second identifier, the advanced messaging system transmits the selected information to the second information source on occurrence of at least one of the following:
(i) on receipt of selected information from the first information source;
(ii) on receipt of request from the second information source for delivery of selected information;
(iii) at a specific date/time as determined by the first information source and/or the advanced messaging system and/or the second information source; and,
(iv) other event as determine by the first information source and/or the second information source.

6. A network configured to permit at least one transaction and to include at least one transfer of funds, at least two customers having access to the network, the network comprising:
at least one computerized advanced messaging system;
at least one financial institution systems, a financial institution being an entity that manages customer accounts containing some form of currency that can be transferred, the financial institution system linked to the advanced messaging system;
at a first customer financial institution, there being first customer account information associated with the first customer financial institution and the first customer, and the first customer account information having a financial institution first customer identifier;
at a second customer financial institution, there being second customer account information associated with the second customer financial institution and the second customer, and the second customer account information having a financial institution second customer identifier;
wherein the network is configured such that at the first customer financial institution, the first customer can request the transmission of the financial institution first customer identifier to the advanced messaging system, and wherein the financial institution first customer identifier is transmitted to the advanced messaging system;
wherein the network is configured such that at the second customer financial institution, the second customer can request the transmission of the financial institution second customer identifier to the advanced messaging system, and wherein the financial institution second customer identifier is transmitted to the advanced messaging system;
wherein within the advanced messaging system, the first customer or the second customer can selectively link the financial institution first customer identifier and financial institution second customer identifier, thus forming a connection between the first customer account information at the first customer financial institution and the second customer account information at the second customer financial institution, such that at least one transaction involving the first customer financial institution, the second customer financial institution, the first customer and the second customer is permitted; and,
wherein a transfer of funds can take place between at least one selected first customer account at the first customer financial institution and the second customer account at the second customer financial institution.

7. The network of claim 6 wherein the financial institution can be at least one of the following:
a Bank;
a Credit Union;
a Building Society;
a Government;
an Employer, where the currency is something of value that can be built up over time and has value, for example hours of overtime;
an Airline, where the currency is frequent flier miles;
a Retailer, where the currency is frequent buyer points; and,
an other entity, where the currency can be transferred.

8. The network of claim 6 wherein the first customer financial institution and the second customer financial institution are the same financial institution.

9. The network of claim 6 wherein the first customer and the second customer are the same customer, where the transfer of funds is between two accounts owned by the same customer.

10. The network of claim 6 wherein the network is configured to permit at least one transaction from a first information source to a second information source such that:
at the first information source the customer can request the delivery of selected information to the advanced messaging system associated with a first associated identifier;
at the second information source the customer can request the receipt of the selected information from the advanced messaging system associated with a second associated identifier;
wherein, within the first information source, the selected information is transmitted to the advanced messaging system such that the selected information is associated with the first identifier, the first information source transmits the selected information to the advanced messaging system on occurrence of at least one of the following:
(i) on the customer request of delivery of selected information;
(ii) on receipt of request from the advanced messaging system for delivery of selected information;
(iii) at a specific date/time as determined by the first information source and/or the advanced messaging system; and,
(iv) other event as determine by the first information source and/or the advanced messaging system;
wherein, within the advanced messaging system, the second information source is identified as a destination for the selected information, wherein the selected information is transmitted to the second information source associated with the second identifier, the advanced messaging system transmits the selected information to the second information source on occurrence of at least one of the following:
(i) on receipt of selected information from the first information source;
(ii) on receipt of request from the second information source for delivery of selected information;
(iii) at a specific date/time as determined by the first information source and/or the advanced messaging system and/or the second information source; and,
(iv) other event as determine by the first information source and/or the second information source.

11. A network configured to permit at least one transaction and to include at least one transfer of information, at least one customer having access to the network, the network comprising:
at least one computerized advanced messaging system;
at least two information systems, an information system being a system of a entity that manages customer information in electronic form, the information system linked to the advanced messaging system;
at an information system, there being customer information associated with the information system and the customer, and the customer information having an information system customer identifier;
wherein the network is configured such that at the information system, the customer can request the transmission of the information system customer identifier to the advanced messaging system, and wherein the information system customer identifier is transmitted to the advanced messaging system;
wherein within the advanced messaging system, the customer can selectively link the information system customer identifier of a first information system and the information system customer identifier of a second information system, thus forming a connection between the customer information at the first information system and the customer information at the second information system, such that at least one transaction involving the first information system, the second information system and the customer is permitted; and,
wherein a transfer of selected information can take place between at least one source information system and a select destination information system.

12. The network of claim 11 wherein the network is configured to permit at least one transaction from a first information source to a second information source such that:
at the first information source the customer can request the delivery of selected information to the advanced messaging system associated with a first associated identifier;
at the second information source the customer can request the receipt of the selected information from the advanced messaging system associated with a second associated identifier;
wherein, within the first information source, the selected information is transmitted to the advanced messaging system such that the selected information is associated with the first identifier, the first information source transmits the selected information to the advanced messaging system on occurrence of at least one of the following:
(i) on the customer request of delivery of selected information;
(ii) on receipt of request from the advanced messaging system for delivery of selected information;
(iii) at a specific date/time as determined by the first information source and/or the advanced messaging system; and,
(iv) other event as determine by the first information source and/or the advanced messaging system;
wherein, within the advanced messaging system, the second information source is identified as a destination for the selected information, wherein the selected information is transmitted to the second information source associated with the second identifier, the advanced messaging system transmits the selected information to the second information source on occurrence of at least one of the following:
(i) on receipt of selected information from the first information source;
(ii) on receipt of request from the second information source for delivery of selected information;
(iii) at a specific date/time as determined by the first information source and/or the advanced messaging system and/or the second information source; and,
(iv) other event as determine by the first information source and/or the second information source.

13. The network of claim 11 wherein the transfer of information is a transfer of medical information, the entities are medical entities, the information systems are medical information systems, the customer information is customer medical information, and the system customer identifiers are medical system customer identifiers, wherein a transfer of selected medical information can take place between at least one source medical system and a select destination medical system.

14. The network of claim 13 wherein the medical entity can be at least one of the following:
a Hospital;
a Medical Practitioner;
an Ambulance, where the medical information relates to identifying a customer and receiving relevant medical information about the identified customer from multiple source medical systems in order to better treat the identified customer;
an Insurance Company, where the medical information relates to the type of insurance the customer may have and the terms and conditions of coverage;
a Pharmacy;
an Employer, where the medical information relates to the type of insurance and benefits the customer has available;
a Biometric Identifier, where the medical information relates to the ability to identify a customer, a medical practitioner or an authorized representative within a medical system;
a technology device, where the medical information relates to the display or storage of received medical information on the technology device;
a data storage system;
a Government; and,
an other entity, where there is information relating to customer that may be of relevance in a transaction relating to medical information.
